(19) United States
(12) Patent Application Publication
(10) Pub. No.: US 2019/0338837 A1
(43) Pub. Date: Nov. 7, 2019

(54) BLOSSOM UMBRELLA OR PARASOL AND CABLE EXPANSION ASSEMBLY

(71) Applicant: SHADECRAFT, INC., Pasadena, CA (US)

(72) Inventor: ARMEN GHARABEGIAN, GLENDALE, CA (US)

(73) Assignee: SHADECRAFT, INC.

(21) Appl. No.: 16/400,914

(22) Filed: May 1, 2019

Related U.S. Application Data
(60) Provisional application No. 62/665,498, filed on May 1, 2018.
(60) Provisional application No. 62/789,471, filed on Jan. 7, 2019.

(51) Int. Cl. F16H 19/00; E04H 15/28; E04H 15/48; G05B 19/042

(52) U.S. Cl. CPC F16H 19/003; E04H 15/28; E04H 15/10; G05B 19/0421; E04H 15/48

(57) ABSTRACT

An arm expansion assembly includes a cable and a hinging assembly and cover; the cable entering a bottom portion of the hinging assembly and cover and enclosed by the hinging assembly and cover. The arm expansion assembly further includes a first arm support assembly and a second arm support assembly, the first arm support assembly connected to a first side of the hinging assembly and cover and the second arm support assembly connected to the second side of the hinging assembly and cover.

### RELATED APPLICATIONS

This application claims priority to U.S. provisional patent application Ser. No. 62/665,498, filed May 1, 2018, entitled “Modular Umbrella or Parasol, and U.S. provisional patent application Ser. No. 62/789,471, filed Jan. 7, 2019, entitled “Parasol Expansion Assembly Utilizing Cable Assembly,” the disclosures of which are both incorporated by reference.

### BACKGROUND

Umbrellas, parasols, shading systems, lighting systems and voice-activated hubs (all of which may be referred to as shading devices) may utilize arms, blades and/or a frame along with shading fabric to provide to cover individuals standing beneath or in an area covered by the shading device. Prior art systems utilized threaded nuts and a collared frame extension or expansion assembly to expand or retract arms or blades and/or frames to open and/or closed positions. However, such prior art systems take up a lot of space and have a number of linkage assemblies that may lead to pieces malfunctioning or being broken more easily.

### BRIEF DESCRIPTION OF DRAWINGS

FIG. 1 illustrates a block diagram of an intelligent shading device according to embodiments

FIG. 2A illustrates a shading device in a closed position (e.g., the arms or blades are in a closed or retracted position) according to embodiments;

FIG. 2B illustrates a shading device in a deployed position (e.g., the arms or blades are in a deployed or open position);

FIG. 3 illustrates a flowchart outlining a process for controlling a shading device according to embodiments;

FIG. 4A illustrates a block diagram power subsystem of a parasol, umbrella or shading system according to embodiments;

FIG. 4B illustrates a rechargeable power source housing according to embodiments;

FIG. 5 illustrates a block diagram of an intelligence housing and components housed therein according to embodiments;

FIG. 6A illustrates a top view of an arm expansion assembly according to embodiments;

FIG. 6B illustrates a side isometric view of an arm expansion assembly according to embodiments;

FIG. 6C illustrates a front view of an arm expansion assembly according to embodiments;

FIG. 6D illustrates a side isometric view with gearing assembly with portions of covers removed according to embodiments;

FIG. 7A illustrates a top view of an arm expansion assembly in an open or deployed position according to embodiments;

FIG. 7B illustrates a side isometric view of an arm expansion assembly in an open or deployed position according to embodiments;

FIG. 7C illustrates a front view of an arm expansion assembly in an open or deployed position according to embodiments;

FIG. 7D illustrates a side isometric view with gearing assembly covers removed of an arm expansion assembly in an arm expansion assembly according to embodiments;

FIG. 8A illustrates a wind sensor housing and a wind sensor according to embodiments;

FIG. 8B illustrates a wind sensor assembly according to embodiments;

FIG. 9A illustrates modular shading devices according to embodiments;

FIG. 9B illustrates a diagram of a modular umbrella shading device including core tubes and cover housings according to embodiments;

FIG. 9C illustrates a top view of outer plastic or metal covers or housings 940 (or wood covers or housings 945);

FIG. 9D illustrates various covers or housings according to embodiments'

FIG. 9E illustrates a close up view of a side portion of a control or operational panel integrated within a housing of an umbrella or parasol;

FIG. 9F illustrates a block diagram of a control or operational panel according to embodiments

FIG. 10A illustrates a base stand or umbrella stand according to embodiments;

FIG. 10B illustrates table top attachments portions according to embodiments.

FIG. 10C illustrates a side view of a top portion (above the table portion) of the table attachment assembly according to embodiments;

FIG. 10D illustrates a top view of a table attachment assembly;

FIG. 10E illustrates a view of a bottom portion of a table attachment assembly (under the table) according to embodiments;

FIG. 11 illustrates a speaker housing module according to embodiments;

FIG. 12A illustrates a top view of an improved arm for an umbrella according to embodiments;

FIG. 12B illustrates a bottom view of an improved arm for an umbrella according to embodiments; and

FIG. 13 illustrates an umbrella support that can connect to both a table top (via a table attachment assembly) and an umbrella stand according to embodiments;

FIG. 14A illustrates an umbrella or parasol arm expansion assembly according to embodiments;

FIG. 14B illustrates a front view of the expansion assembly where covers are on the one or more hinging assemblies and/or covers.

FIG. 15A illustrates a hinging assembly and cover according to some embodiments;

FIG. 15B illustrates a cable being inserted into a hinging assembly or plating assembly according to some embodiments

FIG. 16A illustrates a top view of a hinging assembly and/or cover assembly according to some embodiments;

FIG. 16B illustrates a top view of a cap for an arm support connector tube or shaft according to some embodiments;

FIG. 16C illustrates a side view of an assembled hinging assembly and/or cover assembly according to embodiments;

FIG. 16D illustrates connection of one or more hinging assemblies and/or covers to the arm support connector tube or shaft according to some embodiments;

FIG. 16E illustrates a top view of an arm support connector tube or shaft according to some embodiments; and

FIG. 16F illustrates a side view of an assembled hinging assembly and cover being attached to two arm support assemblies according to some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. For example, a signal transmitted from a motor controller or processor to a motor (or other driving assembly) may pass through glue logic, an amplifier, an analog-to-digital converter, a digital-to-analog converter, another controller and/or processor, and/or an interface. Similarly, a signal communicated through a misting system may pass through an air conditioning and/or a heating module, and a signal communicated from any one or a number of sensors to a controller and/or processor may pass through a conditioning module, an analog-to-digital controller, and/or a comparison module, and/or a number of other electrical assemblies and/or components.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, such as a special purpose computer or a similar special purpose electronic computing device (e.g., such as a balcony shading and power system processor, controller and/or computing device). In the context of this specification, therefore, a special purpose computer or a similar special purpose electronic computing device (e.g., a balcony shading and power system processor, controller and/or computing device) is capable of manipulating or transforming signals (electronic and/or magnetic) in memories (or components thereof), other storage devices, transmission devices sound reproduction devices, and/or display devices.

In an embodiment, a controller and/or a processor typically performs a series of instructions resulting in data manipulation. In an embodiment, a microcontroller or microprocessor may be a compact microcomputer designed to govern the operation of embedded systems in electronic devices, e.g., a balcony shading and power system processor, controller and/or computing device or single board computers, and various other electronic and mechanical devices coupled thereto or installed thereon. Microcontrollers may include processors, microprocessors, and other electronic components.

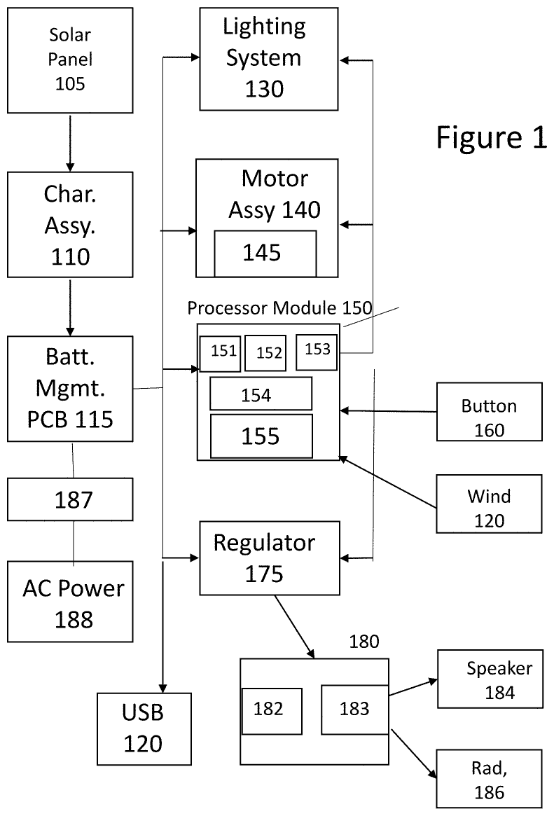

FIG. 1 illustrates a block diagram of an intelligent shading device according to embodiments. In some embodiments, an intelligent shading device may be a parasol, a shading device or an umbrella. In some embodiments, an intelligent shading device 100 may comprise one or more solar panel arrays or solar panel cells 105, one or more solar power chargers or charging assembly 110, one or more battery management assemblies or printed circuit boards (PCBs) 115 and/or one or more USB connectors 120. In embodiments, the one or more solar panel arrays or cells 105 may convert solar energy into high voltage DC power or DC power. In embodiments, the one or more solar power chargers or charging assemblies 110 may be coupled to the one or more solar panel arrays or cells 105. In some embodiments, the one or more solar power chargers 110 may be a maximum power point tracker (MPPT), which may be an electronic DC to DC converter that optimizes an interface and/or connection between one or more solar panel arrays or cells 105 (e.g., PV panels) and a battery management assembly 115 (where the battery management assembly 115 may include a battery bank). In some embodiments, one or more solar power chargers or charging assemblies 110 may convert a higher voltage DC output from one or more solar panel arrays or cells 105 down to a lower voltage needed to charge one or more batteries in a battery management assembly 115. In some embodiments, one or more batteries in a battery management assembly 115 may be rechargeable batteries. In some embodiments, rechargeable batteries may be LiPo batteries. In some embodiments, a battery management assembly 115 may also include a battery holder and/or battery management circuitry (e.g., a printed circuit board, integrated circuits, etc.) to manage the power transfer and/or distribution from the one or more solar power chargers or charging assemblies 110 to the batteries in the battery management assembly 115. In some embodiments, a battery holder may comprise 1 to 4 holders that each may include from 1 to 4 rechargeable batteries. In some embodiments, a battery management assembly 115 may be coupled and/or connector to a USB connector 120. In embodiments, a battery management assembly 115 may convert the DC power to a voltage level utilized by the USB connector 120. In some embodiments, the USB connector 120 may provide power to mobile computing devices or portable computing devices.

In some embodiments, a shading device 100 may comprise one or more processor or microcontroller assemblies 150. In embodiments, the one or more processors or microcontroller assemblies 150 may comprise a system on a chip, where the system on a chip may comprise one or more processors or microcontrollers, one or more memory devices, and/or computer-readable instructions executable by the one or more processors to perform certain actions. In some embodiments, the one or more processor or microcontroller assemblies 150 may comprise one or more microprocessors or controllers 154. In some embodiments, the one or more microprocessors or controllers 154 may be an ARM microprocessor, an AMD microprocessor, and/or an Intel microprocessor. In some embodiments, the one or more processor or microcontroller assemblies 150 may comprise a low-power PAN transceiver 151 (e.g., a low power Bluetooth transceiver (e.g., a BLE module) and/or a wireless local area network transceiver 152 (e.g., a WiFi transceiver for example at 1.2 and/or 2.4 Gigahertz WiFi transceiver). In some embodiments, the one or more processor or microcontroller assemblies 150 also may include a Controller Area Network (CAN) controller 153 (which may also be an ANT controller). In some embodiments, the one or more processors may be cellular transceivers, e.g., cellular transceivers including 3G, 4G or 5G wireless communication protocols. In some embodiments, the one or more processor or microcontroller assemblies 150 may utilize a CAN bus and/or ANT bus to communicate with devices within the assemblies 150 and/or with other devices, assemblies and/or components in the shading device 100. In embodiments, the one or more processor or microcontroller assemblies 150 may also comprise a clock device 155. In embodiments, the clock device 155 may comprise a real time clock. In embodiments, the clock device 155 may not be installed or be resident on the one or more processor or microcontroller assemblies 150. In embodiments, the one or more processor or microcontroller assembly 150 may be a Libre system-on-chip processor. In embodiments, the one or more processor or microcontroller assembly 150 may be a Nordic Semiconductor NRF42832 system-on-a-chip.

In some embodiments, the computer-readable instructions may be executable by one or more processors 154 in the one or more processor or microcontroller assemblies 150 to communicate with the one or more motor systems or subassemblies 140, the one or more lighting systems or assemblies 130, the one orm or more voltage regulators 175, and/or the one or more audio systems 180. In some embodiments, a mobile computing device (e.g., mobile phone, tablet, wearable computing device, etc.) may communicate instructions, commands and/or messages with the one or more processors 154 utilizing the one or more low-power PAN transceiver 151 and/or the one or more wireless LAN (or WiFi) transceivers 152 which are then communicated to the other components, assemblies and/or devices in the shading device 100.

In some embodiments, one or more buttons 160 may be pressed and/or activated which may send a signal and/or command to the one or more processor or microcontroller assembly 150 to have the shading device 100 perform certain actions (such as activating and/or deactivating certain components and/or assemblies (e.g., one or more lighting systems or assemblies 130 and/or one or more motor systems and/or assemblies 140). In some embodiments, one or more buttons 160 may communicate commands or messages to activate or deactivate one or more of the PAN transceiver 151, the WiFi transceiver 152, the microprocessor or controller 154 and/or the memory devices (e.g., to take the shading device out of a sleep state). In some embodiments, only certain components or transceivers may be activated.

In some embodiments, one or more wind sensors 170 may monitor wind speed in an environment surrounding the shading device 100. In embodiments, the one or more wind sensors 170 may communicate a wind speed measurement to the one or more processor or microcontroller assemblies 150. In embodiments, the computer-readable instructions executable by one or more processors 154 in the processor or microcontroller assembly 150 may receive the wind speed measurement, compare the received wind speed measurement to a threshold value, and if the received wind speed measurement is over the threshold value, communicate instructions, messages, commands and/or signals to the motor system 140 to cause the motor system to retract the arm or blade assemblies from an open position to a storage or retracted position. In some embodiments, this protects a shading device 100 from potentially tipping over due to high winds. In some embodiments, the one or more wind sensors 170 may include computer-readable instructions and/or a processor (or similar circuitry) to determine whether or not the captured wind speed measurement is greater than a threshold measurement. If the one or more wind sensors (along the processor and computer-readable instructions (or circuitry)) determines the captured wind speed measurement is greater than the threshold value, the one or more wind sensors 170 may communicate a signal, command, message or instruction to the one or more processors 154, via a bus. In response, computer-readable instructions executable by the one or more processors 154 may communicate instructions, messages, commands and/or signals to the motor system 140 to cause the motor system 140 to retract the arm or blade assemblies to a closed position.

In some embodiments, one or more motor systems 140 may be utilized to retract and/or open one or more arms or blades (and/or a frame system) along with associated shading fabric to provide shade or protection to users, operators and/or devices being protected by the shading device 100. In embodiments, the one or more motor systems 140 may include a rack gear assembly, which may be described in detail later, a cable assembly, which may be described in detail later, and/or a threaded rod or bolt to expand and/or retract the arms, blades or frame. In the embodiment illustrated in FIG. 1, the shading device 100 may only comprise one motor system 140 to open and/or close the arms, blades or frame of the shading device. In embodiments, the one or more motor systems 140 may comprise one or more limit switches 145. In embodiments, the one or more limit switches 145 may prevent motors in the one or more motor systems 140 from rotating at too high of a speed or from generating too much torque.

In some embodiments, the shading device 100 may comprise one or more lighting systems or assemblies 130. In some embodiments, the one or more lighting assemblies may be installed on a center support assembly, arm support assemblies and/or arms of the shading device. In embodiments, the one or more processors and/or microcontrollers 154 may communicate instructions, commands, signals and/or messages via a bus (e.g., a CAN bus) to the one or more lighting systems or assemblies 130 to activate and/or deactivate the lighting assemblies 130. In embodiments, the one or more lighting assemblies 130 may be dimmable or may have adjustable settings. In some embodiments, the one or more lighting assemblies 130 may be synchronized to music being played or reproduced via the audio system 180. In embodiments, the instructions, commands, signals or messages that request or control lighting system synchronization with audio being played or that request dimming or adjusting of the lighting assemblies 130 may be communicated from the one or more processors 150 in the one or more microprocessor or microcontroller assemblies 150. In some embodiments, the one or more lighting assemblies 130 may comprises a lighting controller and/or one or more lighting elements. In some embodiments, the one or more lighting elements 130 may be LED light bulbs, fluorescent light bulbs or filament-based light bulbs. In embodiments, the one or more lighting assemblies 130 may be integrated into the one or more arms or blades of the shading device.

In some embodiments, an audio system 180 may comprise an additional PAN transceiver 182, one or more amplifiers 183 and/or one or more speaker assemblies 184. In addition, the audio system may comprise a radiator device 186 to enhance audio reproduction of transferred or streamed audio files. In embodiments, the additional PAN transceiver 182 may be a BlueTooth (BT) transceiver, a Zigbee transceiver and/or other PAN transceiver. By having an additional PAN transceiver 182, an advantage is provided over prior art shading devices because additional direct communications may be communicated to the audio system 180 without passing through one or more processor or microcontroller assembly 150. This may allow faster playing and/or streaming of music to the audio system 180 in the shading device 100. In some embodiments, the use of a PAN transceiver 152 in the one or more processor or microcontroller assemblies 150 may allow communication to another assembly, component or device (e.g., motor assembly 140 or lighting assembly 130 within the shading device) while there is communication of or streaming of audio files through the PAN transceiver 182 in the audio system or assembly 180 (e.g., at approximately the same time). In some embodiments, this may allow for more efficient operation of a shading device 100. In embodiments, streamed and/or downloaded audio files may be communicated through the additional PAN transceiver 182 to the one or more amplifiers 183 and then to the one or more audio speakers 184.

In some embodiments, power (e.g., voltage and/or current) may be supplied to different components and/or assemblies of the shading device 100. In embodiments, different DC voltages may need to be supplied to different components, devices and/or assemblies of the shading device. In embodiments, some components, devices or assemblies may utilize 12 to 14 Volts DC as an input voltage, whereas other components, device or assemblies may utilize 3.3 to 5 volts DC as an input voltage. In embodiments, the battery management assembly 115 may transfer power to devices that require 12 to 14 Volts DC through a power bus that is separate from a CAN bus. In some embodiments, the battery management assembly 115 may transfer power to one or more voltage regulators 175 and the one or more voltage regulators 175 may communicate 3.3 to 5 Volts DC, via a power bus, to the components or devices that require these voltages for operation. In some embodiments, one or more batteries 115 may need to be recharged by a source separate from a solar panel (due to cloudy weather, storage, malfunction, etc.) In some embodiments, a shading device 100 may comprise a connector 187 (e.g., a power connector). In some embodiments, a cable may connect an AC power source 188 to the connector 187 to provide additional, supplemental or primary power to operate the shading device 100 and/or recharge the battery power source 115. In some embodiments, an audio system 180 may comprise one or more passive radiators 186 to improve sound quality. In embodiments, an audio system 180 may also comprise a woofer, subwoofer, tweeter or additional amplifiers or a combination thereof to provide better audio quality to a user.

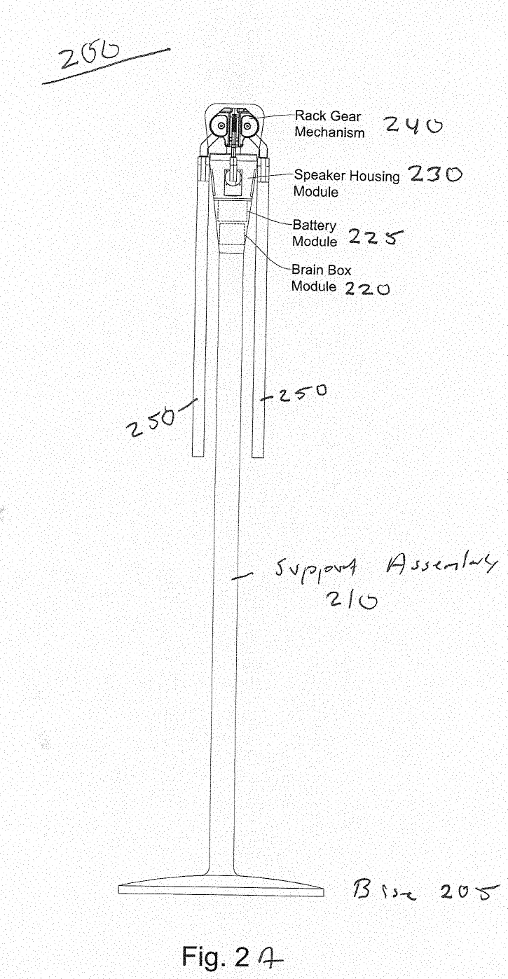

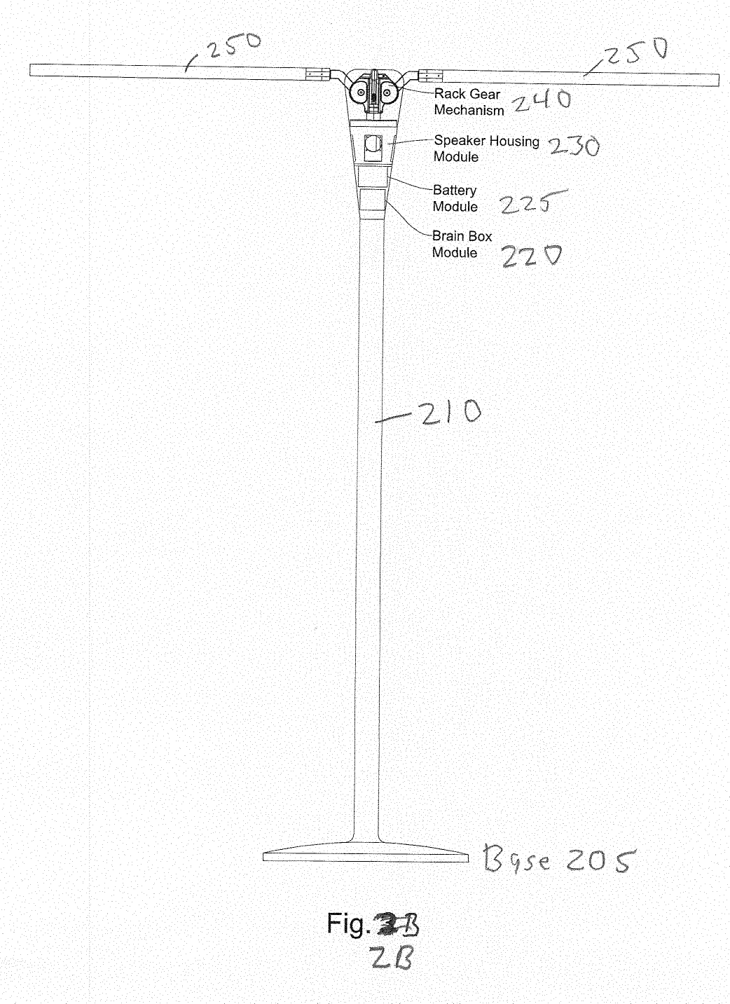

FIGS. 2A and 2B illustrate a shading device associated with a block diagram of FIG. 1 according to embodiments. In some embodiments, FIG. 2A illustrates a shading device in a closed position (e.g., the arms or blades are in a closed or retracted position) according to embodiments. FIG. 2B illustrates a shading device in a deployed position (e.g., the arms or blades are in a deployed or open position). In some embodiments, a shading device 200 may comprise a base or base assembly 205, a support assembly 210, a brain box module 220, a battery module 225, a speaker housing module 230, a rack gear assembly or mechanism 240 and/or one or more arms or blades. In some embodiments, the brain box module 220 may include the microprocessor or controller module as well as other electronic components (e.g., sensor assemblies, power regulators 175, an audio system 180, battery management module 150). In embodiments, a base or base assembly 205 may be in contact with a surface, such as a floor, a patio, grass, sand and/or other surface materials. In some embodiments, a different base or base assembly may be utilized to connect and/or attach to a table, sand, and/or a grass surface. In some embodiments, a support assembly 210 may be coupled and/or connected to a base assembly 210. In some embodiments, a support assembly 210 may comprise a tube or shaft and a cover assembly (which may also be referred to a skin assembly). In some embodiments, a cover assembly may be coupled or connected to a tube and/or shaft. In some embodiments, a tube may be comprised or made of a lightweight metal material or a plastic material. In some embodiments, portions of a motor assembly and/or wires or cables may be installed and/or housed in an interior of a tube or shaft. In some embodiments, other components or assemblies may also be located and/or housed in an interior of a tube or shaft (e.g., motor assemblies and/or linear actuators). In some embodiments, there may be space or openings between a skin assembly and/or a tube or shaft. In embodiments, this may allow components to be installed in housings or assemblies that are located in an opening or space between a skin or cover assembly and a tube or shaft.

In some embodiments, a brain box or electronics module 220 may be connected and/or coupled to a support assembly 210. In embodiments, a brain box or electronics module 220 may house electronics such as one or more processors or controllers, one or more sensors, one or more memory devices, as well as other electronic components. In embodiments, one or more processor or controller assemblies 150 may be located or housed in a brain box. In embodiments, one or more processor or controller assemblies 150 may comprise one or more processors or controllers, one or more memory devices, one or PAN transceivers, other wireless transceivers and one or more clock assemblies (e.g., real time clocks). In embodiments, a brain box or electronics module 220 may also comprise a battery management assembly or PCB 115 and one or more USB ports or connectors 120, although these components may be located or housed in other modules or assemblies. In some embodiments, a brain box or electronics module 220 may comprise one or more wind sensors 170 and/or one or more operational buttons 160, although these components may be located or housed in other modules or assemblies. In some embodiments, a brain box or electronics module 220 may also comprise portions of a motor assembly 140 (e.g., a motor controller or other components or assemblies) although these components may be located or housed in other modules or assemblies. In some embodiments, a brain box or electronics module 220 may also comprise portions of a lighting assembly 130 (e.g., a lighting controller or ballast assembly), although these components may be located or housed in other modules or assemblies. In some embodiments, a brain box or electronics module 220 may also comprise one or more voltage regulators 175, although these components or assemblies may be located or housed in other modules or assemblies. In some embodiments, a brain box or electronics module 220 may be attached and/or connected to a tube or shaft in the shading device. In embodiments, a brain box or electronics module 220 may be attached and/or connected to a cover housing or a skin assembly. In embodiments, a brain box or electronics module 220 may control and/or manage operations of a shading device (e.g., opening or closing of shading device, activate or deactivate a lighting assembly, and/or activate or deactivate an audio system or play music via the audio system).

In some embodiments, a shading device 200 may comprise a battery module 225. In embodiments, a battery module 225 may comprise a plurality of rechargeable batteries. For example, a battery module 225 may comprise between four to twelve rechargeable batteries. In embodiments, a battery module 225 may also comprise or more solar power chargers or charging assemblies 110 (e.g., a MPPT). In embodiments, a battery module 225 may also comprise a battery management assembly 115, which may be a printed circuit board including multiple LiPO4 4S2P batteries). In embodiments, one or more solar power chargers or charger assemblies 110 (e.g., a MPPT) may convert a higher voltage DC output from one or more solar panel arrays or solar cells 105 down to a lower voltage needed to charge one or more batteries in a battery management assembly 115. In some embodiments, a battery management assembly 115 may also include a battery holder and/or battery management circuitry (e.g., a printed circuit board, integrated circuits, etc.) to manage the power transfer and/or distribution from the one or more solar power chargers 110 to the batteries in the battery management assembly 115. In some embodiments, a battery module 225 may reside above an electronics module or brain box module 220. In embodiments, a battery module 225 may be made utilizing additive manufacturing techniques. In some embodiments, a battery module 225 may be comprised of a plastic material or a composite material, or a combination thereof. In some embodiments, a battery module 225 may be coupled or connected to a tube or a shaft. In some embodiments, a battery module 225 may be coupled or connected to a skin or cover assembly. In embodiments, a battery module 225 may be installed or resident in a space between a tube or shaft and or a skin or cover assembly.

In some embodiments, a shading device 200 may comprise a speaker housing module 230. In some embodiments, a speaker housing module 230 may be made utilizing additive manufacturing techniques. In embodiments, a speaker housing module 230 may be comprised of a plastic, a lightweight metal or a composite material, or a combination thereof. In embodiments, a speaker housing module 230 may comprise one or more speakers 184, one or more personal area network transceivers 182 (e.g., Bluetooth transceivers) or one or more amplifiers 183. In some embodiments, a speaker housing module may include all or portions of an audio system 180. In some embodiments, a speaker housing module 230 may be installed or positioned above a battery module 225. In embodiments, a speaker housing module 230 may be connected and/or coupled with a tube or shaft of a shading device 200. In embodiments, a speaker housing module 230 may be flush or in line with a skin or cover assembly of a shading device 200.

In some embodiments, a shading device 200 may comprise a rack gear assembly 240 and one or more arms or blades 250. FIG. 2A illustrates a shading device having one or more arms or blades 250 in a closed or retracted position according to some embodiments. FIG. 2B illustrates a shading device having one or more arms or blades 250 in an open or deployed position according to some embodiments. In some embodiments, a brain box or electronics module 220 may communicate with a motor assembly to operate a rack gear assembly 240, which in turn will move and open or deploy the one or more arms or blades 250 in order to provide shade to users or operators of the shading device 200. In some embodiments, one or more rack gear assemblies 240 and one or more arms or blades 250 may be made utilizing additive manufacturing techniques. In embodiments, one or more rack gear assemblies 240 and one or more arms or blades 250 may be made of a plastic material, a lightweight metal or a composite material, or a combination thereof. In some embodiments, the one or more rack gear assemblies 240 or the one or more arms or blades 250 are described below.

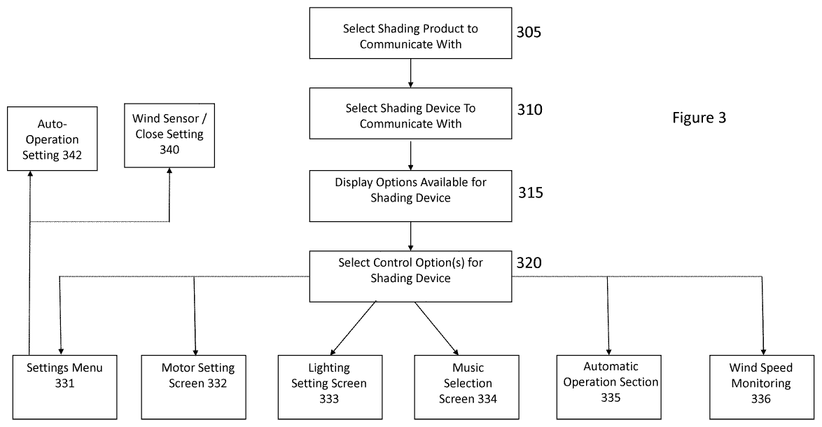

FIG. 3 illustrates a flowchart outlining a process for controlling a shading device according to embodiments. Embodiments described herein are meant to be illustrative examples rather than be limiting with respect to claimed subject matter. Likewise, an embodiment may be simplified to illustrate aspects and/or features in a manner that is intended to not confuse and/or hide claimed subject matter through specificity and/or details. Embodiments in accordance with claimed subject matter may include all of, less than all, or more than blocks 305-342. In some embodiments, the order of blocks 305-342 may merely be an illustrative order and other orders may be possible.

In some embodiments, computer-readable instructions executable by one or more processors or microcontrollers may perform the process described below. In some embodiments, the computer-readable instructions may be executable by one or more processors on a mobile computing device (e.g., a smartphone, a tablet, a wearable computing device), a server computing device, a desktop computing device, a laptop computing device, or a combination thereof. In some embodiments, in other words, the application software may be resident on a mobile computing device, a server computing device, a desktop computing device, or a combination thereof. In embodiments, a graphical user interface or menu may be presented on a monitor of one of the computing devices discussed above, to allow a user or operator to select items to be executed or steps to be executed. In some embodiments, a computing device or even a shading device may comprise voice recognition software to allow a user or operator to select actions and/or options to be performed via voice commands.

Initially, in step 305, a shading product or shading product group may be selected to communicate with. In embodiments, such as hotels, restaurants, outdoor concerts, office buildings, etc., a fleet of shading devices may be controlled via one or more computing devices. In embodiments, for example, a user or operator (or hospitality manager) may select to communicate with single axis parasols (e.g., expansion only parasols) in a specific geographic area such as by a pool. In embodiments, a user and/or operator may utilize the software application (e.g., SMARTSHADE software) to set up shading products type (e.g., BLOOM parasols, SUNFLOWER umbrellas, etc.) and/or shading product groups (e.g., based on geography or location) that the user or operator may communicate commands or instructions to.

In some embodiments, in step 310, once a shading product type or a shading product group is selected, one or more specific shading devices may be selected from a list of shading devices that are displayed through the software application. In embodiments, a single shading device may be selected. In other embodiments, multiple shading devices may be selected and the same actions may be performed on all of the selected shading devices. Alternatively, in other embodiments, multiple shading devices may select and the software application may include a split screen, where different options and/or actions may be selected.

In some embodiments, in step 315, the computer-readable instructions executable by one or more processors of the one or more computing devices may display options available for the one or more shading devices. In some embodiments, the options and/or actions may be displayed as icons, menu items, universal symbols and/or alphanumeric texts. In some embodiments, the options may include, but are not limited to: 1) settings or setup menu; 2) motor activation/deactivation; 3) sensor monitoring or activation/deactivation; 4) lighting activation/deactivation or adjusting; 5) automatic operation activation/deactivation; and/or 6) audio system activation/deactivation and/or setting of music. In other embodiments, other options may include, but are not limited to: 1) video activation/deactivation, storage and/or streaming; 2) addition sensor monitoring and/or activation/deactivation; 3) music and/or lighting system synchronization; 4) wireless transceiver selection and/or activation deactivation; and/or proximity sensor/motion detector monitoring and/or activation/deactivation.

In some embodiments, in step 320, a user or operator may select control options and/or actions for the selected shading device. In embodiments, as discussed above, the options and/or actions may be selected by touchscreen interaction, pressing mechanical/electromechanical buttons, voice commands, cursor selection and/or gesture-based selection. In some embodiments, in response to selection of control options and/or actions one of a plurality of menus or input screens may be displayed on the computing device.

In some embodiments, in step 321, a user or operator may select a settings or threshold menu in order to establish measurements for different assemblies or components and/or different times for activation of assemblies and/or components. In embodiments, for example, in step 342, a user or operator may select to establish or set when a shading device may be operated in an automatic mode. In embodiments, a user or operator may select a time and date at which to initiate automatic operation (e.g., 4:00 pm EST or 8:00 am PST), minutes until the shading device may initiate automatic operation (e.g., in 10 minutes or 2 hours), or under what conditions a shading device may initiate automatic operation (e.g., wind speed low, temperature reading in a specific range, and/or time of day). In embodiments, the entered or received time, date, time period and/or environmental conditions may be stored in one or more memory devices of a computing device (e.g., mobile computing device, server computing device, wearable computing device and/or desktop computing device) and/or a memory device of the shading device.

In some embodiments, in step 340, a user or operator may be able to select a wind speed (or other environmental sensor measurement at which to retract arms or blades of a shading device and/or possibly deactivate certain components of a shading device. In embodiments, for example, a user or operator may select that if a wind speed sensor is above 25 miles per hour, a shading device should be closed. In embodiments, for example, a user or operator may select that if a humidity sensor reading or air quality sensor readings are greater than specified input values, the shading device may be deactivated or closed and/or certain components may be deactivated (e.g., wireless transceivers and/or lighting assemblies).

In some embodiments, in step 332, a user or operator may select to open or close the blades or arms of the shading device by communicating with one or more motor assemblies. In some embodiments, a motor assembly may be an expansion motor assembly. In some embodiments, the computer-readable instructions executed by the processor of the computing device (e.g., mobile computing device, tablet computing device, wearable computing device, server computing device, desktop computing device or a combination thereof) may present a user with three options: open, close or stop. These options may be presented audibly, as icons, as text or as a combination thereof. In embodiments, when the computer-readable instructions executed by the processor of the computing device receive the selection, a command, instruction or signal is communicated to an expansion motor assembly to perform the requested action. In embodiments, other motors (e.g., azimuth rotation motors and/or elevation rotation motors) may also be activated, deactivated and/or stopped utilizing similar techniques to those discussed above if a shading device has more than three rotations of axis (and thus may have three motor assemblies).

In some embodiments, in step 333, a user or operator may select to activate or deactivate the lighting assembly by communicating with the one or more lighting assemblies. In embodiments, a user or operator may adjust a lighting intensity of the one or more lighting assemblies according to embodiments. In embodiment, the computer-readable instructions executed by the one or more processors of the computing device, may present a user with a lighting icon and/or a lighting adjustment indicator (e.g., such as a slide ranging from completely off to high intensity). In embodiments, these options may be presented audibly, as icons or as text or as a combination thereof. In embodiments, these options and/or actions may be selected via voice commands, touchscreen inputs, keystrokes or gestures or a combination thereof. In embodiments, when the computer-readable instructions executable by the processor receive the lighting option or action, a command, instruction or signal is communicated to the one or more lighting assemblies to activate, deactivate and/or adjust an intensity of the lighting assembly.

In some embodiments, in step 334, a user or operator of a shading device may select music to be played on an audio system of the shading device. In embodiments, the computer-readable instructions executed by the one or more processors of the computing device may present the user with one or more available music library (or music app) software programs for a user or operator to identify and select. In embodiments, these options may be presented as icons, as text or audibly, or a combination thereof to a user or operator. In embodiments, the different music app options may be selected via voice commands, touchscreen inputs, keystrokes or gestures or a combination thereof. In embodiments, for example, available music apps may be iTunes, Spotify, Pandora, Amazon Music as well as others. In embodiments, when the computer-readable instructions executable by the one or more processors receive the music app selection command, a PAN transceiver (e.g., a Bluetooth transceiver) may communicate with an additional PAN transceiver (e.g., located in an audio system of the shading device) to begin downloading and/or streaming the audio or music files to the audio system of the shading device, where the audio files may be communicated to one or more amplifiers and further to one or more speakers to play the music for the user or operator.

In some embodiments, in step 335, automatic operation mode may automatically occur based upon settings that were previously setup. In embodiments, an automatic operation mode may occur at a pre-established initiation time and a shading device may open arms and/or blades. In embodiments, a shading device and its arms and/or blades may close at a pre-established closing time.

In some embodiments, in step 336, a user or operator may monitor wind speed of an area around a shading device via a wind sensor. In embodiments, the computer-readable instructions executed by the one or more processors of the computing device may communicate with one or more wind sensors (and/or other sensors) and receive a sensor measurement from the one or more wind sensors. In embodiments, the one or more computer-readable instructions executable by the one or more processors of the computing device may present a user or operator with the wind speed in a display area on the monitor of the computing device. In embodiments, the wind speed measurement may be presented audibly, visually or via text or a combination thereof. In some embodiments, the computer-readable instructions executable by the one or more processors of the computing device may present a current wind speed measurement and/or a sliding scale for a wind speed sensor sensitivity. In embodiments, a user or operator may select a low or high sensitivity which is a value at which a shading device may close or retract its arms or blades in order to safely maintain operation. In embodiments, a user or operator may also select a timeframe at which shading device may deploy after an acceptable wind speed measurement is received. (e.g., 2 or 3 minutes or 15 minutes). In embodiments, if the computer-readable instructions executable by the one or more processors of the computing device receive a wind speed measurement value above the preset threshold value, a command, instruction and/or message may be communicated to the one or more motor assemblies to close and/or retract the arms or blades of the shading device (and potentially turn off the shading device if the conditions are especially dangerous). While the discussion above relates to wind sensors (the discussion also applies to other environmental sensors measuring potentially dangerous conditions, (e.g., humidity sensors, temperature sensors, air quality sensors, ultraviolet sensors, carbon monoxide or carbon dioxide sensors).

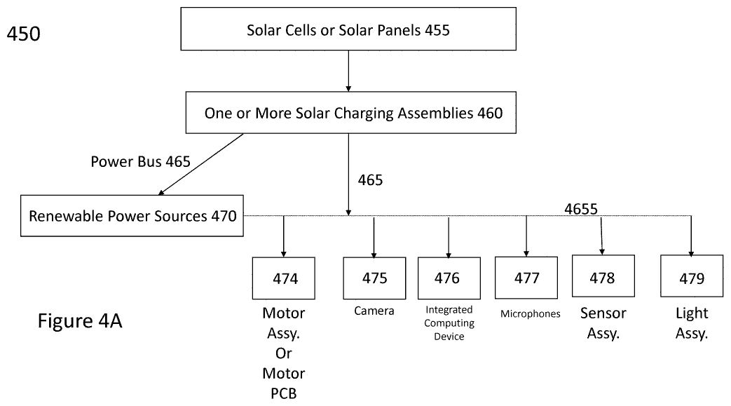

FIG. 4A illustrates a block diagram power subsystem of a parasol, umbrella or shading system according to embodiments. In embodiments, a power subsystem 450 comprises one or more solar cells, solar cell arrays or solar cell panels 455, one or more solar charging assemblies 460, one or more power buses 465, one or more rechargeable batteries 470, and one or more electrical or electro-mechanical assemblies 474 475 476 477 478 and 479. In some embodiments, although not pictured, the power subsystem 450 may also provide power to one or more microprocessor, processor or controller modules 150 (which are not shown in FIG. 4A). In embodiments, one or more solar cells, solar cell arrays or solar cell panels 455 may generate electrical energy or electrical power from a light source (e.g., the sun). In embodiments, one or more solar cells, solar cell arrays or solar cell panels 455 may transfer power or electrical energy to one or more solar charging assemblies 460. In embodiments, one or more solar charging assemblies 460 may be solar charge controllers or MPPT controller. In embodiments, one or more solar charging assemblies 460 may comprise computer interfaces that monitor and control power output from one or more solar cells, solar cell arrays and/or solar cell panels. In embodiments, indicators may monitor, control and/or display output power (e.g., one or more LED lighting assemblies 474 may show that power is being supplied and that some power is being output via a solar charging assembly 460). In embodiments, one or more solar charging assemblies 460 may also display voltage and/or current being supplied from one or more solar panels, solar cell arrays or solar cell panels 455 and/or may also display voltage and/or current being output by one or more solar charging assemblies 460 as well as displaying how much current is being pulled from a load terminal (and thus supplied to a rechargeable power source, components and/or assemblies).

In some embodiments, one or more solar charging assemblies 460 may supply power to one or more rechargeable power sources (e.g., rechargeable batteries) 470. In some embodiments, one or more solar charging assemblies 460 may supply power (e.g., voltage and/or current) to a power bus and/or power cables 465. In embodiments, the power supplied to a power bus and/or power cables 465 from one or more solar charging assemblies 460 may be at an approximate level of 12 volts (or between 11 to 17 volts). In embodiments, one or more solar charging assemblies 460 may provide power to a rechargeable power source 470 at a level between 11 and 17 volts (or at approximately 12 volts). In some embodiments, a power bus and/or one or more power cables 465 may supply power (e.g., voltage and/or current) to one or more components, assemblies or apparatuses (e.g., one or more electrical or electro-mechanical assemblies 474 475 476 477 478 and 479). For example, electrical component 324 may be a motor control printed circuit board or a motor controller that causes a motor to expand one or more arms to deploy or retract (or may be a processor, controller, microcontroller or microprocessor module); reference number 475 may be an integrated camera that captures images around an umbrella; reference number 476 may be an integrated computing device 476 that may include computer-readable instructions stored in one or more memory devices that are executable by one or more processors in the integrated computing device; reference number 477 may be one or more microphones (e.g., a microphone array to capture ambient noise as well as voice commands); reference number 478 may be one or more sensor assemblies or sensors (e.g., directional sensors, environmental sensors and/or proximity or motion sensors); and reference number 479 may be one or more lighting assemblies. In embodiments, an umbrella and/or parasol may not include or comprise all of the above-listed components. In some embodiments, components such as a motor control PCB 474, one or more cameras 475, one or more integrated computing devices 476, one or microphones 477, one or more sensors or sensor assemblies 478, and one or more lighting assemblies 479 may not utilize 12 volts and if not then these components and/or assemblies may include a voltage regulator to provide a lower voltage, such as 3.3 Volts and/or 5 volts, that maybe utilized and/or required by these components. In some embodiments, one or more renewable power sources (e.g., rechargeable batteries) 470 may be placed in a battery housing. In embodiments, one or more battery housings 470 may be placed around a center core assembly, as may be discussed in detail later.

FIG. 4B illustrates a rechargeable power source housing according to embodiments. In some embodiments, a rechargeable power source housing 401 may comprise one or more power source holders (e.g., battery holders) 405 406 407, one or more power source tops 408 409 410, a circular plate 415, one or more rechargeable power sources 418 419 422 421 and wiring 425 coupled to one or more power buses 430. In embodiments, each of the one or more power source holders 405 406 407 may hold one or more rechargeable power sources 418 419 422 421 (four may be shown in FIG. 4B), but any number of rechargeable batteries may be utilized. In embodiments, one or more rechargeable power sources 418 419 422 421 may be connected to wiring 425 which in turn may be coupled or connected to one or more power buses to provide + or −12 volts. In embodiments, one or more power source tops 408 409 410 may be connected to one or more corresponding power source holders 405 406 407 via a snap fit connector and/or tabs. In embodiments, a circular plate 415 may be adhered or connected to the one or more power source holders 405 406 407. In embodiments, a circular plate 415 and/or power source holders 405 406 407 may be an integrated piece and may be manufactured using additive manufacturing or 3D printing techniques. In embodiments, a circular plate 415 may have a hole 416 in a middle in order to let a tubular assembly (e.g., a shaft 470) to pass through a middle and be able to construct the remainder of the umbrella. In embodiments, a circular plate 415 may be connected, adhered or fastened to either a base assembly or a core assembly module. In some embodiments, a rechargeable power source housing 401 may be located in a bottom base housing, although it may be located in any portion of a core assembly module (and potentially base assembly). In embodiments, a rechargeable power source housing 401 may be located in a section of a base assembly. In some embodiments, a rechargeable power source housing may also be located in a center section of a support assembly 210. In embodiments, a power source housing 401 may include less power source holders (e.g., only holder for four rechargeable batteries) for smaller intelligent umbrellas or parasols.

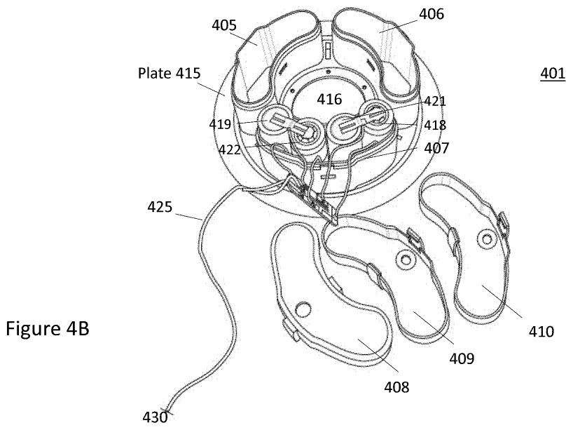

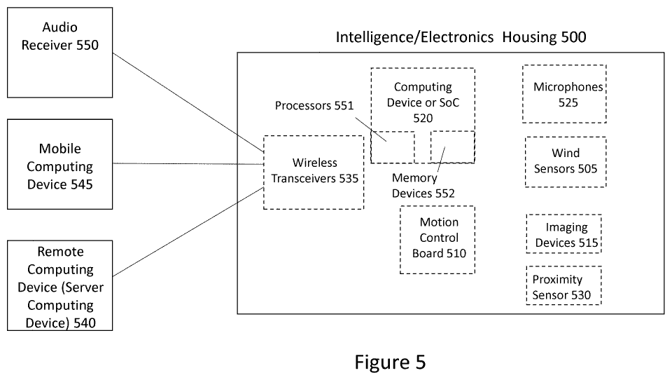

In some embodiments, an umbrella, parasol and/or shading system may comprise an intelligence housing (e.g., a brain box) to control a number of functions and/or features of the umbrella, parasol or shading system. FIG. 5 illustrates a block diagram of an intelligence housing and components housed therein according to some embodiments. In some embodiments, an intelligence housing 500 may be manufactured utilizing additive manufacturing techniques (e.g., 3D printing). In some embodiments, an intelligence electronics housing may be made of plastic material, a composite material or a lightweight metal material or a combination thereof. In some embodiments, an intelligent housing 500 may comprise one or more wind sensor assemblies 505, one or more motor control assemblies or motion control boards 510 (e.g., for controlling operation of, for example, an expansion motor), one or more imaging devices 515, one or more integrated computing devices (e.g., Raspberry Pi) or one or more systems-on-a-chip (or processors, controllers, microcontrollers or microprocessors), one or more microphones or line arrays 525, one or more PAN transceivers 535 (e.g. a Bluetooth transceiver) or other wireless communication transceivers, which also may be located in a speaker housing module, and one or more proximity sensors 530. In embodiments, an intelligence housing 500 may comprise one or more wireless communication transceivers 535. In embodiments, wireless communication transceivers 535 in an intelligence housing may communicate with one or more remote computing devices (e.g., one or more server or a cloud-based servers 540, one or more mobile computing devices 545 and/or one or more audio receivers 550. In embodiments, one or more systems-on-a chip (SoC) may comprise one or more processors or controllers 551, one or more memory devices 552, and/or one or more wireless transceivers 535 (e.g., one or more PAN transceivers (e.g., low energy BLE transceiver), one or more WiFi transceivers and/or one or more cellular transceivers). In some embodiments, these components may also be located on separate circuit boards and/or physical structures.

In some embodiments, a parasol, umbrella or shading system may comprise a novel or new arm expansion assembly which may or may not include a new rack gear assembly. In embodiments, the arm expansion assembly may be utilized with existing umbrellas and/or parasols by replacing existing arm expansion assemblies and/or frames. For example, in embodiments, the expansion assembly may replace the arm extension assemblies and/or arm support assemblies of other umbrella which have an open center support assembly and/or a motor driving an actuator in a linear up and down direction. In embodiments, a shading device may comprise an arm expansion assembly coupled to a motor and/or motor controller. In embodiments, a manual knob or cranking device may manually operate the new arm expansion assembly. In other words, it may be manually operated or automatically operated. In embodiments, a shading device may also comprise an azimuth motor assembly for rotating a shading system about a base assembly, an elevation motor assembly for rotating an upper part of a support assembly with respect to a lower part of a support assembly, and the new or novel arm expansion assembly, described herein, for expanding and/or retracting arms, blades and/or a frame of a shading device (and the associated shading fabric). In embodiments, the arm expansion assembly may also be part of a shading system for a lighting assembly and/or a shading system for a voice-activated hub.

However, in some embodiments, a shading device does not necessarily need rotate about a base (e.g., have an azimuth motor) and/or include or comprise an elevation rotation. In other words, the shading device may only include the unique arm expansion assembly to open and/or close the arms, blades and/or frame of the shading device. Alternatively, the shading device may include one of the azimuth rotation assembly or the elevation rotation assembly and also may include the unique arm expansion assembly.

In some embodiments, a new arm expansion assembly may have a lighter weight than prior art arm expansion assemblies due to the use or utilization of 3D printed materials for many components, assemblies, or structures. For example, in embodiments, the housings that comprise the arm supports, arm extension housings, speaker housings, battery housings and skins or covers of a shading device may be made utilizing additive manufacturing techniques. In embodiments, the additive manufacturing techniques may include 3D printers that utilize plastics, composites or metals, or a combination thereof to generate the low weight yet resilient components, assemblies or structures. This may allow personalized or unique designs and configurations and may also allow for easy interchangeability and/or modification of the assemblies to different shapes, because there are no set molds necessary in additive manufacturing printers. In embodiments, a new arm expansion assembly may also hide many mechanical assemblies or components from view, which is not only pleasing aesthetically, but also is safer than prior art expansion assemblies. The new configuration is safer than prior art arm expansion assemblies the new gearing assemblies and/or hinging assemblies may not be in view or available for touching, and thus may not be accessible to catch onto or snag have fingers, hair and/or articles of clothing. In embodiments, in addition, a new arm expansion assembly may be modular and may be easily attached or detached to an existing linear actuator and/or a linear actuator housing or tubing. In addition, the new arm expansion assembly may also allow the ability to attach or detach different types of arms or blades to adjust to different user requirements or different shading protection needs (e.g., the length and/or widths of the arms, blades or frames may be shortened and/or lengthened depending on requested or desired configuration). In embodiments, shapes of the arms or blades may also be changed easily. In addition, because the arm support assemblies are detachable from arm expansion housings (e.g., by unscrewing connectors), the arms supports or arm support assemblies may also change shape, have different section shapes, have different thicknesses, have different widths, thicknesses or lengths, or different angles with respect to the different sections.

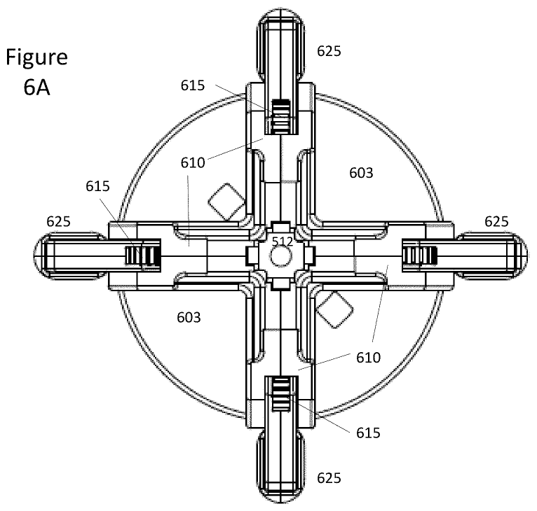

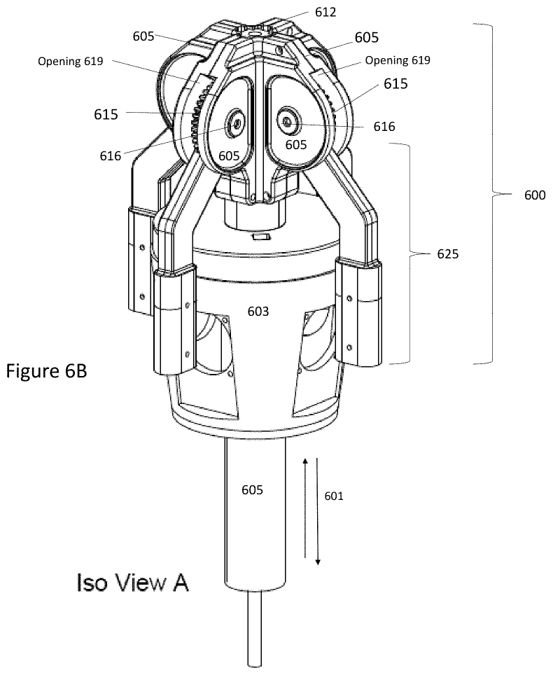

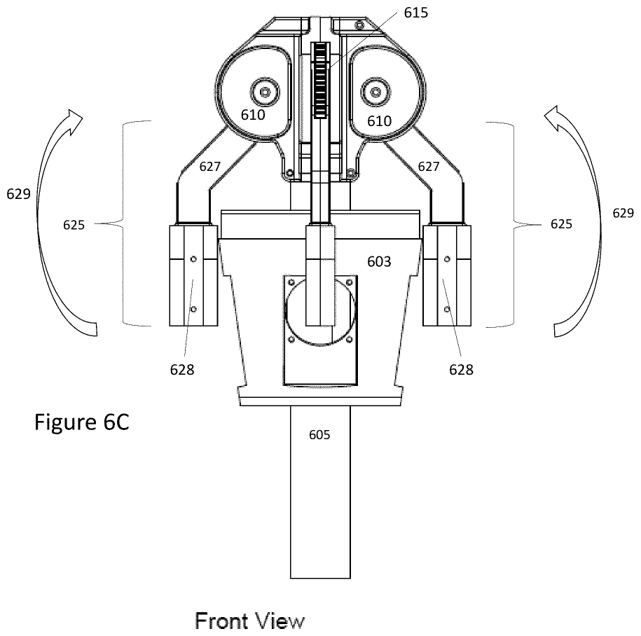

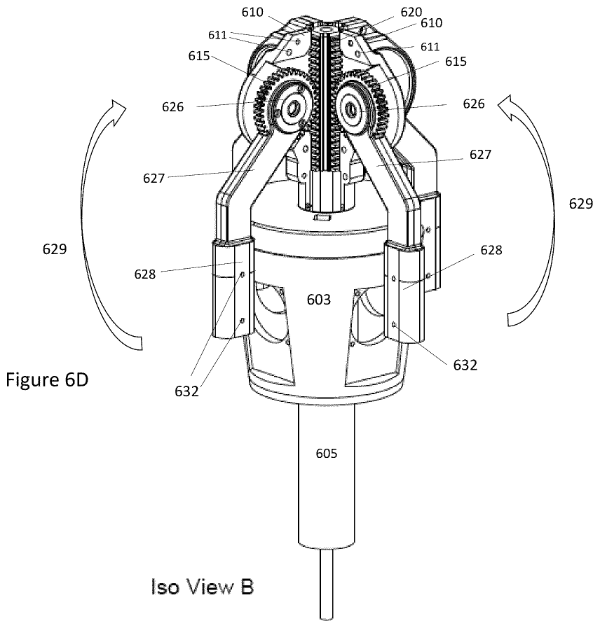

FIG. 6A illustrates a top view of an arm expansion assembly according to embodiments. FIG. 6B illustrates a side isometric view of an arm expansion assembly according to embodiments. FIG. 6C illustrates a front view of an arm expansion assembly according to embodiments. FIG. 6D illustrates a side isometric view with gearing assembly with portions of covers removed according to embodiments. In some embodiments, a shading device may comprise a speaker and/or amplifier housing 603, an actuator housing 605 and an arm expansion assembly 600 (which may further includes structures and assemblies located above an amplifier housing 603). In embodiments, an arm expansion assembly 600 comprises one or more arm extension gear housings 610, one or more arm expansion gears 615, at least one rack gear 620 and one or more arm supports 625.

In embodiments, an actuator housing 605 may comprise an aluminum housing or aluminum tube. In embodiments, an actuator housing 605 may include a linear actuator installed inside and/or connected or coupled to an interior surface of an actuator housing. In embodiments, a linear actuator may be coupled or connected at one end (e.g., an upper end) to a rack gear or rack gear assembly 620. In embodiments, the terms rack gear or rack gear assembly may be utilized interchangeably. In embodiments, a linear actuator may be connected or coupled at a second end (e.g., a lower end) to a motor assembly. In embodiments, a linear actuator may move in a vertical direction up or down (as illustrated by arrow 601), which results in upwards or downward vertical movement of the rack gear 620. In embodiments, a rack gear 620 may be made of a metal material. In embodiments, a rack gear 620 may be made of a plastic material or a composite material, or combination thereof. In embodiments, a rack gear 620 may be manufactured utilizing additive manufacturing techniques and be created utilizing a 3D printer.

In embodiments, as illustrated in FIGS. 6A-6D, an arm expansion assembly may comprise four expansion gear housings 610. In other embodiments, an arm expansion assembly may comprise two, three or more than four expansion gear housings 610. In embodiments, a number of expansion gear housings 610 may correspond to a number of arms in a shading device. In embodiments, the expansion gear housings 610 may each provide a housing and/or be coupled to an arm expansion gear 615. In embodiments, an expansion gear housing 610 may completely or partially encircle or enclose an associated arm expansion gear 615. In embodiments, the one or more expansion gear housings 610 may be connected or coupled to a top end of an actuator housing 605 (e.g., a top end of a metal tube). In embodiments, the one or more expansion gear housings 610 may be connected to the actuator housing 605 via one or more fasteners, screws and/or welds. In embodiments, the one or more expansion gear housings 610 may be made or manufactured utilizing a 3D printer (e.g., via additive manufacturing techniques). The 3D printer may utilize a plastic material, a composite material or a combination thereof to make, create or manufacture the one or more expansion gear housings 610.

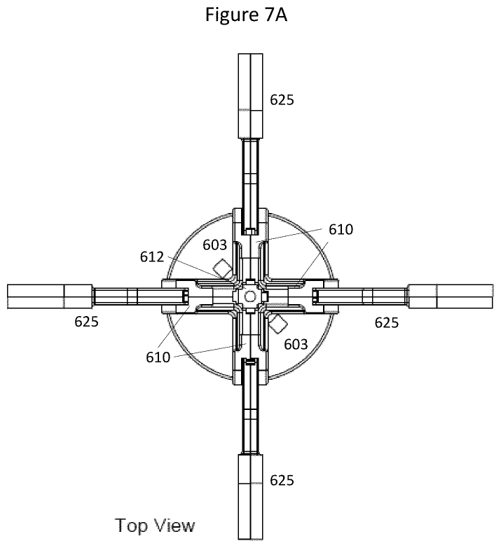

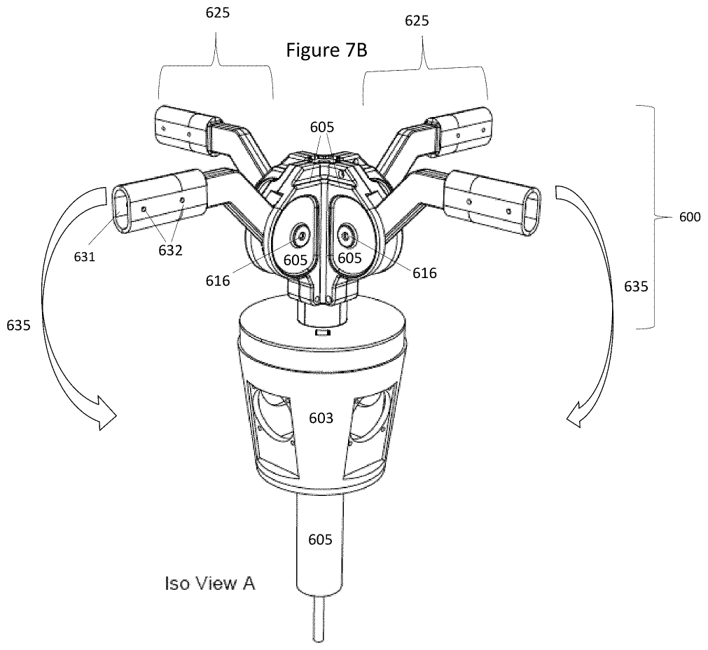

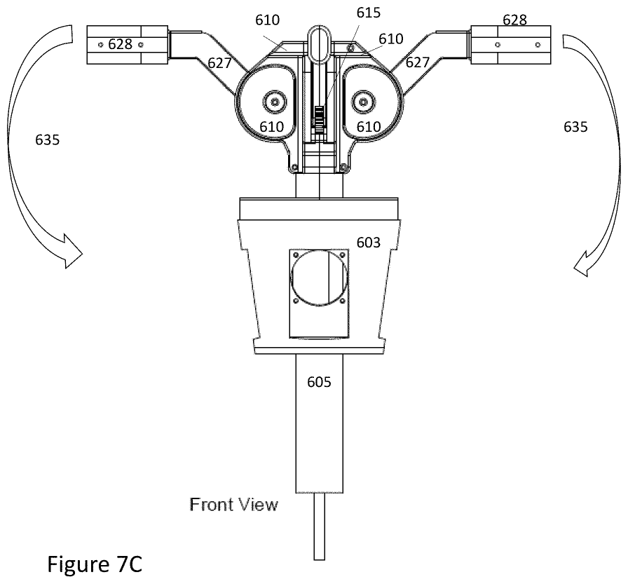

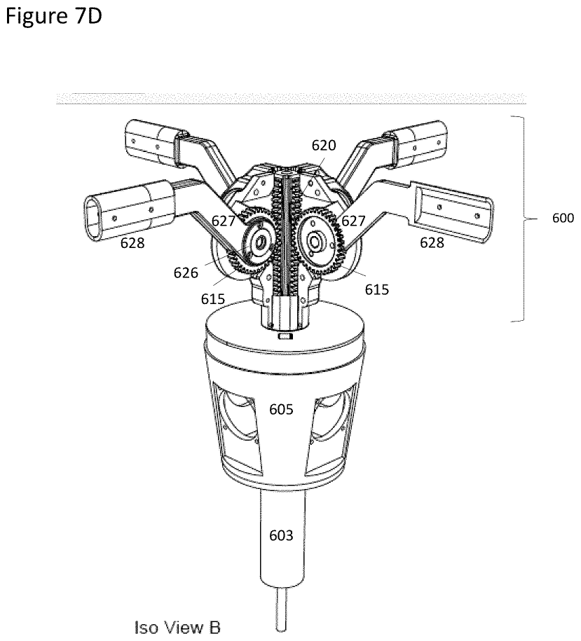

FIG. 6D illustrates an arm expansion assembly with one of the expansion gear housings 610 removed (leaving three extension gear housings). In embodiments, an expansion gear housing 610 may comprise two sides or sections, where the two sides or sections are placed at approximately 90 degrees with respect to each other. In embodiments, an angle at which the two sections of the expansion gear housings 610 are placed or positioned may be dependent on the number of expansion gear housings (and thus the number of arms). In embodiments, the angle may range between 70 to 110 degrees. In embodiments, the expansion gear housing 610 may comprise an opening 616 on each side to allow a connector to pass through and fasten the arm expansion gears 615 to the associated arm supports 625. In embodiments, the one or more expansion gear housings 610 may further include openings or recesses 611 to allow fasteners to connect adjacent gear housings assemblies 610. In embodiments, the one or more expansion gear housings 610 come together or meet at a top of an arm expansion assembly and may create an area 612 where a sensor module may be located or positioned. In embodiments, when adjacent one or more expansion gear housings 610 are connected, an opening 619 is formed, in which the one or more expansion gears 615 are positioned. The space or opening 619 is illustrated in FIGS. 6B and 7B. In embodiments, the space or opening 619 allows the expansion gears 615 to rotate and the arm support assemblies to rotate to either an opened and/or closed position. In embodiments, when the one or more expansion gear housings meet and/or positioned, a space may be formed in the middle of the one or more expansion gearing housings 610. In embodiments, the space may be a circular space, a rectangular space and/or a square space. In embodiments, an arm support 625, an arm expansion gear 615 and an expansion gear housing 610 may be one part that is made utilizing additive manufacturing techniques and require few if no connectors or fasteners. In embodiments, a one-piece expansion gear housing 610, an arm support 625 and an arm expansion gear 615 may be placed next to a rack gear 620 and a plurality of these one-piece combinations may be utilized to connect or couple the one or more arms to the rack gear to allow for deployment or retraction of the arms. Advantages of a one-piece arm support 625, arm expansion gear 615 and/or expansion gear housing 610 are that this configuration is easy to replace, is stronger structurally because it is one piece and not three pieces, and can allow for easy modification of a parasol if changing from one to three arms or assemblies. In another embodiment, an arm expansion gear housing 610 and an arm expansion gear 615 may be created as one piece and may need less fasteners and/or connectors.

In embodiments, a rack gear 620 may be located in the space in a middle of the one or more expansion gear housings 610 (as illustrated in FIGS. 6D and 7D). In embodiments, a sensor module may be coupled or connected on top of a rack gear 620. In embodiments, a rack gear 620 may be located under a sensor module 612.

In embodiments, one or more arm supports 625 may be coupled or connected to associated one or more arm expansion gears 615. In embodiments, when one or more extension gear housings 610 are coupled or connected to each other, an opening may be formed (e.g., opening 619). In embodiments, the one or more arm supports 625 may be inserted and/or positioned into the opening 619. In embodiments, fasteners may be inserted through openings 616 in the associating extension gear housings 610, the associated arm expansion gears 615 and the arm supports or arm support assemblies 625. In embodiments, as illustrated in FIGS. 6A to 6D, the one or more arm supports or arm support assemblies 625 may comprise of a circular section 626 (where the one or more arm supports 625 connect to the associated arm expansion gears 615), a second section 627, and a third section 628, where the third section 628 is positioned at an angle with respect to the second section 627. In embodiments, the third section 628 may be positioned at an angle with respect to the second section 627 in order to take up less space when the shading system is in a closed position or a retracted state, as is illustrated in FIGS. 6A-6D. In such an illustrative embodiments, a majority of the third section 628 of the one or more arm supports 625 may rest against an outside surface of a speaker and/or amplifier housing 603.

FIG. 7A illustrates a top view of an arm expansion assembly in an open or deployed position according to embodiments. FIG. 7B illustrates a side isometric view of an arm expansion assembly in an open or deployed position according to embodiments. FIG. 7C illustrates a front view of an arm expansion assembly in an open or deployed position according to embodiments. FIG. 7D illustrates a side isometric view with gearing assembly covers removed of an arm expansion assembly in an arm expansion assembly according to embodiments. In embodiments, the third section 628 of the one or more arm supports 625 may be positioned at an angle with respect to the second section 627 so that when the arm support (and attached arms) 625 are in a fully opened or deployed position, the third section 628 of the arms supports or arm support assemblies 625 (and the attached arms) are positioned at approximately a 90 degree angle with respect the ground and the actuator housing (and thus central support tube) (as is illustrated in FIGS. 7A-7D). The rotation of the one or more arm supports 625 is illustrated by the arrow and reference number 629 in FIGS. 6C-6D. In embodiments, the rotation of the one or more arm supports 625 is illustrated by arrow and reference number 635 in FIGS. 7B and 7C. In embodiments, reference number 629 illustrates an opening movement of the one or more arm supports 625 according to embodiments. In embodiments, the circular section 626, the second section 627 and the third section 628 may be a unitary piece, which is formed during additive manufacturing. In embodiments, as is illustrated in FIGS. 6A to 6D and FIGS. 7A to 7D, thicknesses and widths of the circular section 626, the second section 627 and the third section 628 may be different. In embodiments, one end of a third section 628 of the one or more arm supports 625 is open. In embodiments, at least a portion of the third section 628 of the one or more arm supports 625 is hollow. In embodiments, one or more arms are placed into the hollow opening or recess 631 of the one or more arm supports 625. In embodiments, the third sections 628 of the one or more arm supports include openings 632 to allow arms and/or blades to be connected and/or inserted into the one or more openings 632. This allows the one or more arms to be changed in order in case of malfunction, broken parts or an arm length needs to be changed.

In some embodiments, a motor assembly may receive commands from one or more processors in a shading device. In embodiments, a motor controller in a motor assembly may communicate commands or signals to a motor to rotate. In embodiments, a rotation of a motor may cause a linear actuator to move in a downward vertical direction. In embodiments, movement of a linear actuator may cause movement and/or rotation of a rack gear 620 in a downward direction, as illustrated by reference number 601. In embodiments, the movement and/or rotation of a rack gear 620 in a downward vertical direction engages the one or more arm expansion gears and causes the one or more arm expansion gears 615 to rotate. In embodiments, the engagement and/or rotation of the one or more arm expansion gears 615 causes the coupled one or more arm supports 625 to rotate and/or lift from a resting or closed position and move to a deployed or open position (as is illustrated in FIGS. 7A-7D). In alternative embodiments, the rotation of a motor may cause a linear actuator to move in an upward vertical direction, which may cause the rack gear to move in an upwards vertical direction. In embodiments, movement of the rack gear in an upward vertical direction may cause the one or more arm extension gears to rotate, which may cause the one or more arm supports 625 to rotate and/or lift from a closed position to an open position. Similarly, the movement and rotation of the rack gear 620 may cause arms supports 625 to move from an open position to a closed position and/or resting position (after receiving commands, instructions, signals or messages from one or more processors) by causing the assemblies described above to operate in the opposite fashion and/or direction.

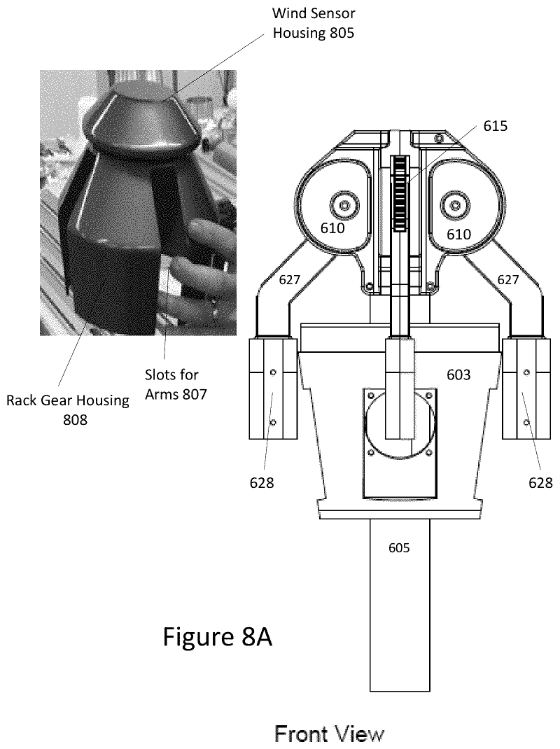

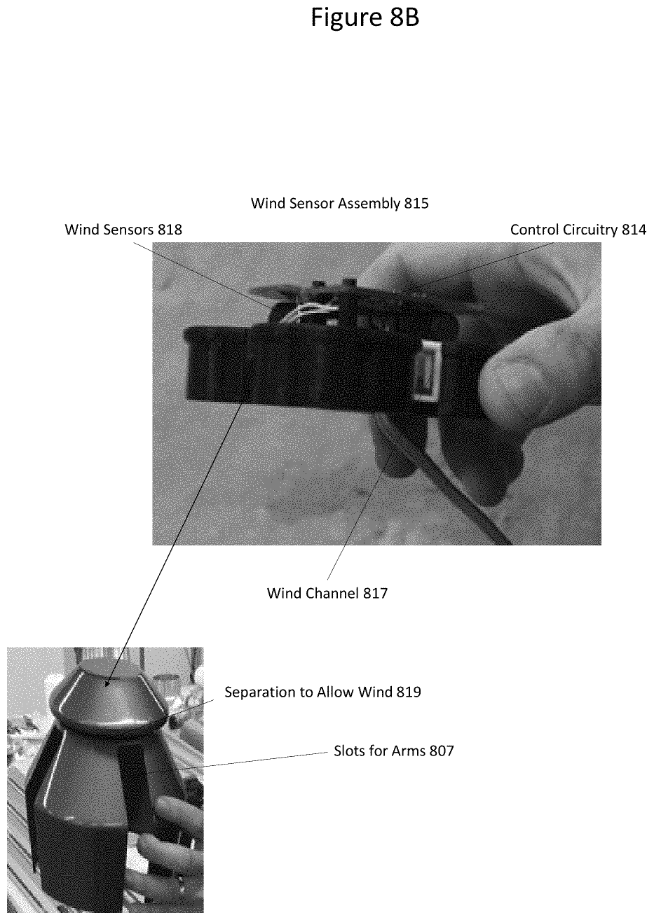

FIG. 8A illustrates a wind sensor housing and a wind sensor according to embodiments. In some embodiments, a wind sensor housing 805 rests on top of a rack gear housing 808. In some embodiments, a rack gear housing 808 is on top of a shading device and provides coverage for a rack gear assembly. In embodiments, a rack gear housing 808 has slots 807 so that arm or blade support assemblies or arms of a shading device can operate (e.g., open and close) while during non-operation, inner mechanisms and/or mechanical assemblies of the shading device may not be viewed. In embodiments, a wind sensor housing 805 may be made of a plastic material, a composite material, a lightweight metal or a combination thereof. In embodiments, a rack gear housing 808 may be made of a plastic material, a composite material, a lightweight metal or a combination thereof. In some embodiments, a wind sensor housing 805 and a rack gear housing 808 may be made utilizing additive manufacturing techniques. In some embodiments, wind may enter a wind sensor housing 805 through slots 807 in the rack gear housing and travel upward into a wind sensor assembly 815, as shown in FIG. 8B. In some embodiments, there may be some openings provided in between the rack gear housing 808 and the wind sensor housing 805 and wind speed measurements may be taken from wind entering through these openings.

FIG. 8B illustrates a wind sensor assembly according to some embodiments. In some embodiments, wind may enter the wind sensor housing through openings 819 where the wind sensor housing 805 connects to the rack gear housing 805. In some embodiments, a wind sensor assembly 815 comprises one or more wind sensors 818 (either electrical or electro-mechanical) (not shown), one or wind channels 817 and/or electronic control circuitry 814. In some embodiments, the wind may enter the wind sensor assembly 815 and travel through the one or more wind channels 817 to the one or more wind sensors 818. In some embodiments, computer-readable instructions executable by one or more processors of the shading device may receive wind sensor measurements from the one or more wind sensors 818, compare the wind sensor measurements to predetermined thresholds, and generate commands, instructions or messages to send to 1) speakers (to alert users or operators of high wind speed and that the umbrella may be closing); 2) lighting assemblies (to alert users through specific lighting patterns); and 3) one or more motor controllers (to cause a shading device to move to a retracted or closed position).

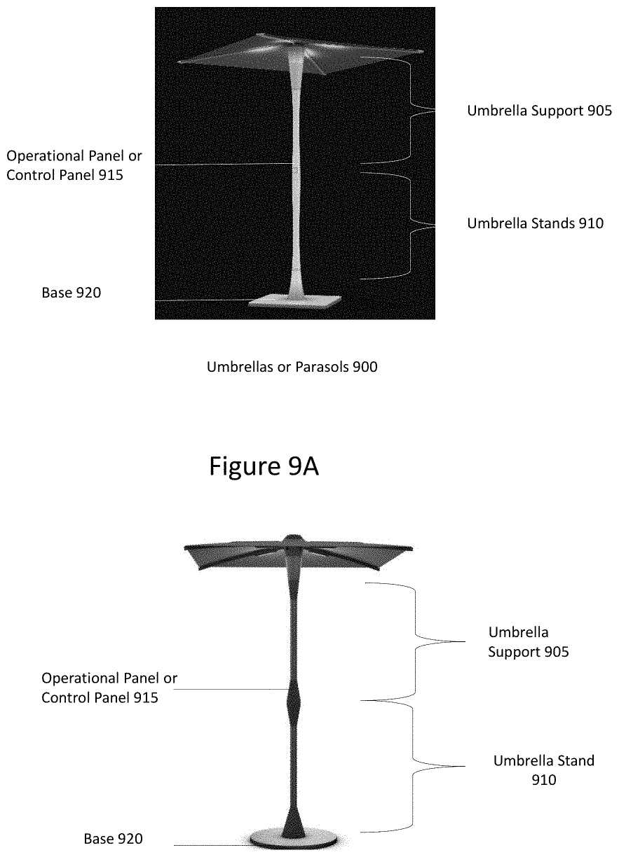

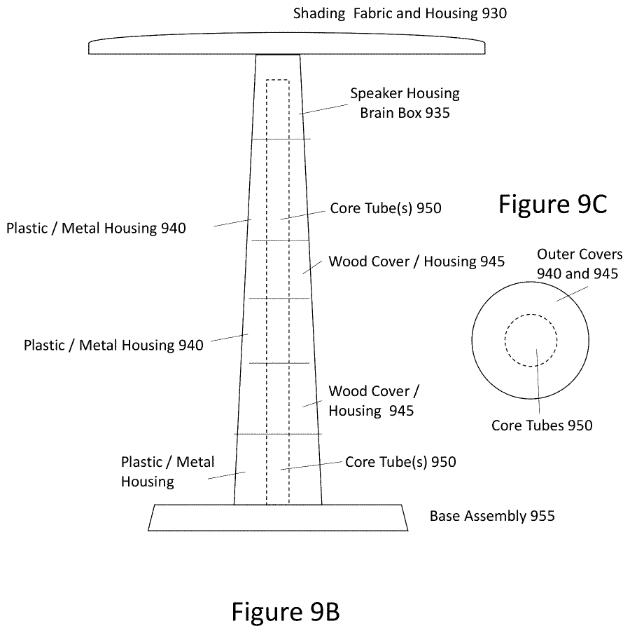

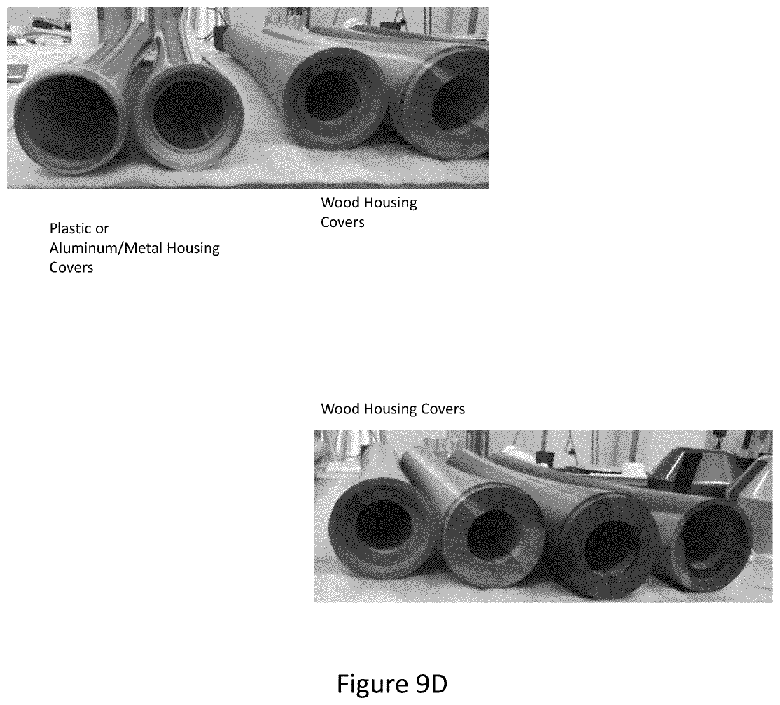

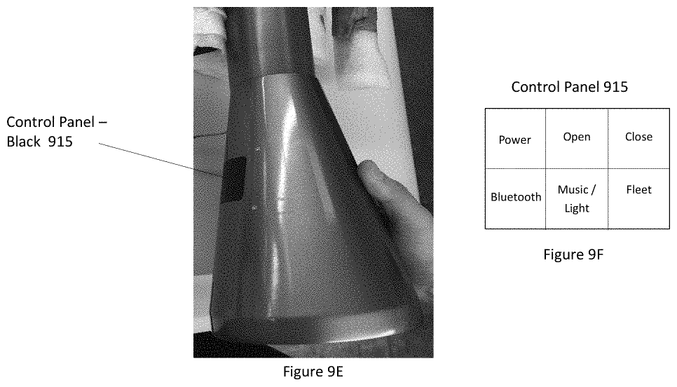

FIG. 9A illustrates modular shading devices according to some embodiments. In some embodiments, a modular shading device 900 may comprise a base 920, a control panel or operational panel 915, an umbrella support assembly 905 and an umbrella stand 910. In embodiments, an umbrella support 905 may connect at one end to an umbrella stand 910 and may be on top of an umbrella stand 910. In embodiments, another end of an umbrella support 905 may connect or couple to arm support assemblies or arms. In some embodiments, an umbrella stand 910 may couple or connect to a base or base plate 920. In some embodiments, different portions of an umbrella stand and/or umbrella support may be made of a wood material. In embodiments, different portions of an umbrella stand 910 and/or umbrella support 905 may be made of a lightweight metal. In some embodiments, different portions of an umbrella stand 910 and/or umbrella support 905 may be made of a plastic material. In some embodiments, an umbrella support 905 may be detachable from an umbrella stand 910. In some embodiments, an umbrella support 905 may be attachable to a table top via a table connection assembly (as discussed below). Thus, in embodiments, thus an umbrella support 905 may be utilized with multiple umbrella stands 910 and/or may also be utilized with a table connection assembly. In some embodiments, a customer or operator may purchase an umbrella support 905 and a table connection assembly with no umbrella stand. In some embodiments, a customer or operator may purchase an umbrella support 905 and an umbrella stand 910 with no table connection assembly.

FIG. 9B illustrates a diagram of a modular umbrella shading device including core tubes and cover housings according to embodiments. In embodiments, an umbrella or parasol may comprise a number of different sections or modules. In some embodiments, one or more core tubes 950 may run though a middle of umbrella or parasol. In some embodiments, one or more core tubes 950 may be coupled or connected to base assembly 955. In some embodiments, one or more core tubes 950 may be coupled or connected to a shading fabric and housing 930. In some embodiments, a single core tube 950 may run from the base assembly 955 up to the shading fabric and housing 930. In some embodiments, more than one core tubes 950 may connect to each other via welds, fasteners or other connection mechanisms. In some embodiments, one or more core tubes 950 may be hollow. In embodiments, one or more core tubes 950 may be made of a lightweight metal for support. In some embodiments, one or more core tubes 950 may be made of a fiberglass, a plastic or a composite, or a combination thereof. FIG. 9C illustrates a top view of outer plastic or metal covers or housings 940 (or wood covers or housings 945). In embodiments, a speaker and electronics housing 935 may include one or more speaker assemblies and other electrical components, which may be referred to as a brain box.

In embodiments, the outer covers or housings (e.g., plastic/metal 940 or wood covers or housings 945) may be stacked on top of each other as shown in FIG. 9B (or may be positioned around each other). The outer covers or housings (940 or 945) may be cylindrical with holes in the middle in order to slide over the one or more core tubes 950. For example, in FIG. 9B, a plastic or metal housing may first be placed over a core tube near a base assembly 955. In embodiments, then in order, a wood cover or housing 945 may be placed over a core tube 950 and on top of a plastic or metal housing 945, followed by a plastic or metal housing 940, then a wood cover or housing 945, a plastic or metal housing and a speaker and electronics housing 935. Less or more of these housings or covers may be utilized. In some embodiments, each of these covers or housings may be slid down over a core tube or placed around a core tube. In some embodiments, a core tube or tubes 950 may be hollow with nothing inside. In some embodiments, a motor and/or motor assembly may be housed inside a core tube or tubes. In embodiments, a core tube or tubes 950 may house electronic components, integrated circuits, or mechanical components. In embodiments, batteries for example, may be resident outside of core tube or tubes 950. In embodiments, sensors may be installed or positioned outside of a core tube or tubes 950 but on an interior or wood covers and/or housings 945 and/or plastic or metal covers and/or housings 940. In embodiments, a wood cover or housing 945 may be utilized to provide additional structural support for an umbrella or parasol. In some embodiments, a wood cover or housing 945 is also a better material for heat dissipation. Accordingly, a motor or circuit board may be installed or positioned in an area near a wood cover or housing 945 to provide for greater heat dissipation. FIG. 9D illustrates plastic or metal covers or housings according to embodiments and also wood covers or housings according to embodiments.

FIG. 9E illustrates a close-up view of a side portion of a control or operational panel integrated within a housing of an umbrella or parasol according to some embodiments. FIG. 9F illustrates a block diagram of a control or operational panel according to some embodiments. In some embodiments, a control or operational panel 915 may allow for manual or location operation of the umbrella or parasol. In some embodiments, a control or operational panel 915 may override commands or instructions from a cellular phone. In some embodiments, a control or operational panel 915 may have four buttons (power on, open umbrella, close umbrella and/or activate Bluetooth communications). In some embodiments, a control or operational panel 915 may have six buttons (power on/off, open umbrella, close umbrella, activate Bluetooth or PAN communications, activate music and/or lighting, and/or enter into fleet management mode, where this umbrella may control multiple umbrellas or this umbrella may be controller by another umbrella). In some embodiments, pushing an open or close button on the control or operational panel 915 may communicate a command and/or start a sequence that results in audible sounds or speech being emitted from speakers such as “move away the umbrella is closing” or “stand back the umbrella is opening.” Similarly, the other buttons may operate in the same way.

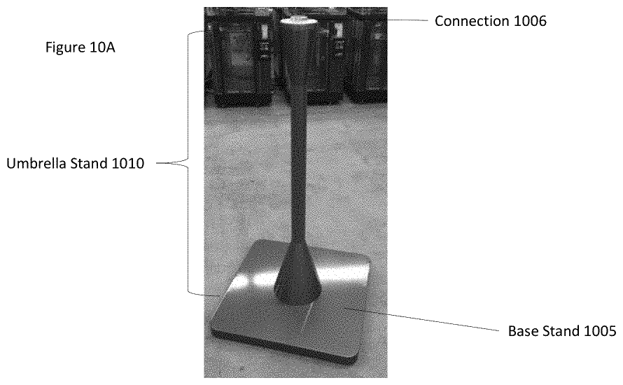

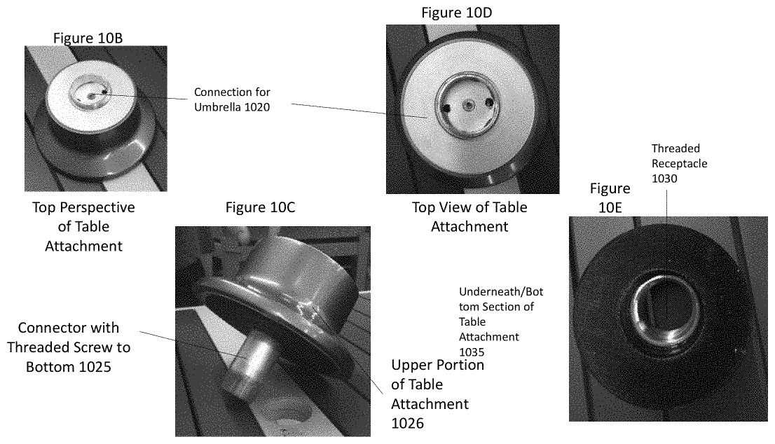

FIG. 10A illustrates a base stand or umbrella stand according to some embodiments. FIGS. 10B-10E illustrates table top attachments portions according to some embodiments. In some embodiments, an umbrella stand 1005 is attached to a base stand 1010. In some embodiments, a base stand 1010 may be circular in shape, rectangular in shape or triangular in shape. In embodiments, an umbrella support may be connected or coupled to a top end of the umbrella stand 1005 as illustrated as reference number 1006. FIG. 10B illustrates a top view of a table attachment assembly for a modular umbrella or parasol according to embodiments. Reference number 1020 illustrates a connector for an umbrella which includes a threaded receptacle. FIG. 10C illustrates a side view of a top portion (above the table portion) of the table attachment assembly according to some embodiments. In some embodiments, the top portion or section 1026 may rest on top of a table and may include a connector tube with threads 1025. In some embodiments, a connector tube with threads 1025 may be connected to a bottom portion may be inserted through the table. FIG. 10D illustrates a top view of a table attachment assembly according to some embodiments. FIG. 10E illustrates a view of a bottom portion of a table attachment assembly (under the table) according to embodiments. In some embodiments, a bottom portion or section 1035 of a table attachment assembly may be circular or square with a hole in the middle including threaded receptacles 1030 to allow the connector tube with threads to screw into the bottom portion or section 1035 of the table attachment assembly.

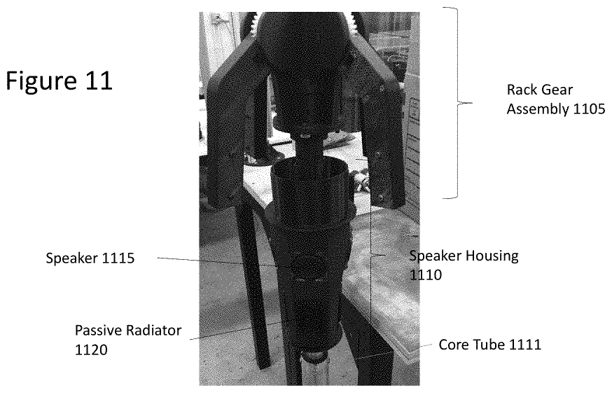

FIG. 11 illustrates a speaker housing module according to embodiments. In embodiments, a speaker housing or speaker housing module 1110 is located underneath a rack gear assembly 1105. In embodiments, a speaker housing 1110 may be wrapped around a core tube or core tube assembly 1111 (or have a core tube or core tube assembly running right through the middle). In embodiments, a speaker housing 1110 may have one or more speakers 1115 and/or one or more passive radiators 1120. In embodiments, the one or more speakers 1115 are integrated within the speaker housing 1110. In embodiments, the one or more passive radiators 1120 are integrated with the speaker housing 1110. In embodiments, the one or more passive radiators improve sound provided by speaker assembly by providing a better base sound. In embodiments, the one or more passive radiators 1120 are located directly below the associated one or more speakers in order to provide higher quality sound. In embodiments, the speaker housing 1110 may comprise four speakers 1115 and/or four passive radiators 1120. In embodiments, the speaker housing 1110 may also comprise one or more audio transceivers (e.g., a Bluetooth or PAN transceiver), one or more amplifiers, one or more subwoofers, or one or more tweeters or a combination thereof.

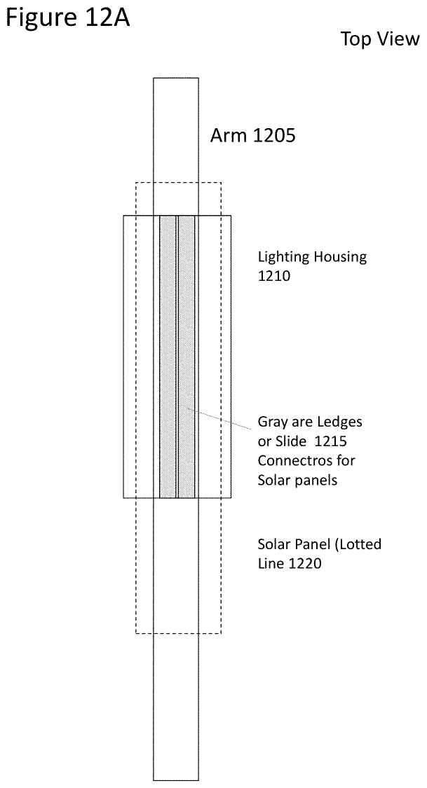

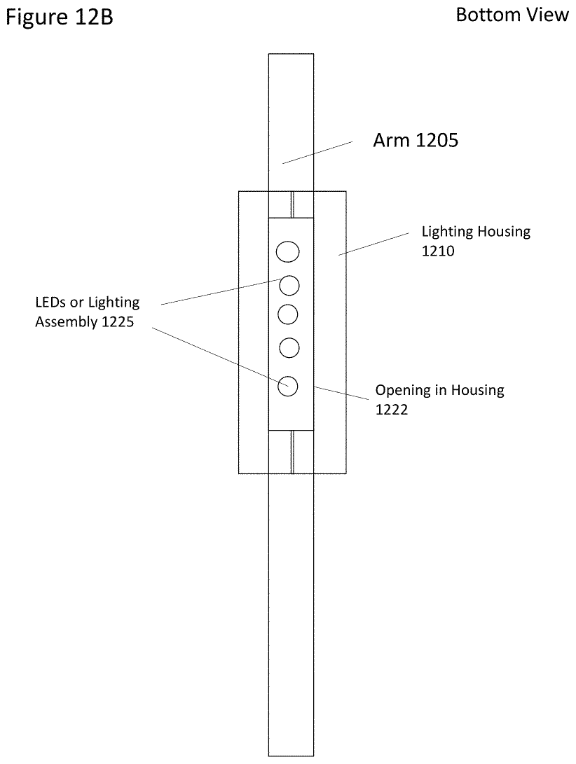

FIG. 12A illustrates a top view of an improved arm for an umbrella according to some embodiments. FIG. 12B illustrates a bottom view of an improved arm for an umbrella according to some embodiments. In some embodiments, an umbrella or parasol may have one or more arms. In some embodiments, shading fabric may be connected to the arms by having the one or more arms fit into pockets at edges of the shading fabric. In some embodiments, an umbrella or parasol may have two, three, four, six or eight arms. In some embodiments, an arm may need to include or have attached thereto solar panels and/or lights. In some embodiments, a new and improved arm 1205 may have a lighting housing 1210 attached to the arm and surrounding the arm. In embodiments, a lighting housing 1210 may have two pieces that fasten or snap-fit to each other or connect to the arm. In embodiments, the lighting housing 1210 may have ledges or slide connectors 1215. In embodiments, the ledges or slide connectors 1215 may allow a solar panel or solar cell array 1220 to slide over the ledges or slide connectors 1215 and be held in place on an opposite side of where the lighting assemblies are resident or positioned within the lighting housing. In some embodiments, a shading fabric is positioned or installed over each of the arms 1205 of the umbrellas and an outer end of the arm 1205 may fit into a pocket of the shading fabric. In some embodiments, the shading fabric may be one piece. In locations where are arms, a shading fabric may have an opening (e.g., a long rectangular opening) to allow a ledge or slide connector 1215 to rest on top of the shading fabric. In some embodiments, the solar cell array or panel 1220 is then inserted onto the ledge or slide connector 1215 and held in place by the ledge or slide connector 1215. In the bottom view of the arm (e.g., FIG. 12B), the lighting housing 1210 has an opening 1222. In the opening 1222, the lighting housing 1210 has one or more LED lights or lighting assemblies 1225. This allows for light to be projected downward onto the table or to the base. Thus, the lighting housing 1210 serves two purposes (one to have the LEDs shine light downward and a second to provide connectors or a slide to connect and hold a solar panel on the opposed side of the lighting assemblies or LEDs). No other umbrellas or parasols have this feature.

FIG. 13 illustrates an umbrella support that can connect to both a table top (via a table attachment assembly) and an umbrella stand according to embodiments. The left-hand side shows connecting an umbrella support to an umbrella stand. The right-hand side shows connecting an umbrella support to a table attachment assembly.

FIG. 14A illustrates an expansion assembly including a cable system in an umbrella according to embodiments. In some embodiments, the parasol expansion assembly includes one or more arm or blade support assemblies 1431, 1432, 1433 1434 1435 1436 1437 or 1438, one or more hinging assemblies and/or covers 1420, 1421, 1422, and 1423 (not shown), a center support assembly or center tubular support 1410, one or more steel cables 1415 1416 1417 1418 (1418 is not shown in FIG. 14A), a cap 1455, and/or arm support connector tube or shaft 1450. In some embodiments, one end of the steel cables 1415 1416 1417 1418 may be coupled to a linear actuator (e.g., via a connector or connecting plate). In some embodiments, two arm or blade support assemblies 1431 1435 1433 1434 are attached to each of two hinging assemblies and/or covers 1420 and 1422 (in other words two arm or blade support assemblies may be attached to one hinging assembly). In some embodiments, an arm or blade is connected to the arm support assemblies 1431 1435 1433 1434 and a shading fabric is connected and/or attached the one or more arms or blades, although this is not shown in FIG. 14A. This completes the upper part of the umbrella. The umbrella performs in similar functions to the umbrella described in FIG. 6A in that it opens and closes the arms and/or fabrics of the umbrella. FIG. 14B illustrates four arms and/or eight arm support assemblies as an example arm expansion assembly. In some embodiments, the one or more hinging assemblies and/or covers 1420, 1421 and 1422 may be detachable and/or removable from the arm support connector tube or shaft 1450. This allows for easy replacement of the hinging assembly and/or cover in case of malfunction. This is an advantage over umbrellas that have a frame that is interconnected where a service person may need to visit the site or the whole umbrella may need to be sent in for repair. The detachability and removability of the arm support connector tube or shaft 1450 from the hinging assemblies and/or covers may also allow for easy upgrade of the umbrella. In some embodiments, the arm support connector tube or shaft 1450 may be detachable or removable from the center support assembly 1410. In some embodiments, the arm support connector tube or shaft 1450 may have one or more channels in which the respective one or more hinging assemblies and/or covers 1420, 1421, and 1422 (plus an additional hinging assembly and/or cover 1423 may be inserted). In some embodiments, the one or more channels may run vertically down the arm support connector tube or shaft 1450. In some embodiments, the arm support connector tube or shaft 1450 may be inserted on an interior of the center support assembly 1410. In some embodiments, the arm support connector tube or shaft 1450 may be coupled and/or connected to a top or a top end of a center support assembly 1410, as illustrated in FIG. 14B. In some embodiments, a cap 155 may be coupled ad/or connected to a top or top end of the arm support connector tube or shaft 1450 to keep water or other liquids from entering the interior or inside of the arm support connector tube or shaft 1450 and to make this portion of the umbrella watertight or waterproof.

FIG. 14B illustrates a front view of the expansion assembly where covers are on the one or more hinging assemblies and/or covers. In FIG. 14B, the arm support assemblies 1431 1432 1433 1434 1435 1436 1437 and 1438 may be in a closed, retracted of down position. In some embodiments, the arm support assemblies may be comprised of a connection portion or section 1480 and an extension section 1481. In some embodiments, the connection portion or section 1480 may be shorter than the extension section 1481. In some embodiments, the connection portion or sections 1480 of two arm support assemblies may be attached or connected to a hinging assembly and/or cover (e.g., hinging assembly or cover 1420). In some embodiments, when the umbrella is closed, the connection portion 1480 of the arm support assembly may be tilted or positioned slightly downward from 90 degrees with respect to the center support assembly 1480 (e.g., ranging from 85 to 45 degrees with respect to the center support assembly 1480). In some embodiments, when closed, the extension section 1481 of the arm support assemblies are directed or positioned downward to the ground. In some embodiments, when closed, the extension section 1481 of the arm support assemblies may be almost parallel to the center support assembly 1410. In some embodiments, the connection section 1480 may be positioned at between a 45 degree to 90 degree angle with respect to the extension section 1481 of the arm support assemblies. This allows for clearance of the arm support assemblies from the remainder of the umbrella and the arm expansion assembly. When the umbrella is open and/or the arms are in an expanded position, the extension section 1481 of the arm support assemblies may be 90 degrees with respect to the center support assembly (as shown in FIG. 14A), which will also put the arms themselves be approximately 90 degrees with respect to the center support assembly. The connection section 1480 of the arm support assemblies (when the umbrella is in an open position will be approximately 120 degrees to 135 degrees with respect to the center support assembly 1410. In some embodiments, although 90 degrees is mentioned, the extension part of the arm support assemblies may be in a position of 45 to 135 degrees. Reference numbers 1421 and 1422 are illustrated in FIG. 14B (and 1423 and 1425 are hidden from view). In some embodiments, two arm support assemblies may be attached to the one or more hinging assemblies and/or covers. In some embodiments, for example, as illustrated in FIG. 14B, arm support assemblies 1433 and 1434 may be attached via connectors to hinging assembly and/or cover 1421 and arm support assemblies 1431 and 1432 may be attached or connected via fasteners or connectors to hinging assembly and/or cover 1422. Although the hinging assemblies and/or covers are not shown, arm support assemblies 1435 and 1436 may be attached to another hinging assembly and/or cover and arm support assemblies 1417 and 1418 may be attached or connected to another hinging assembly and/or cover.

In some embodiments, an interior portion of the arm support assemblies 1431 1432 1433 1434 1435 1436 1437 and 1438 may have a circular recess to accept an inner hub of the hinging assemblies and/or covers 1420, 1421, 1422, and 1423. In some embodiments, the one or more steel cables 1415 1416 1417 1418 may be positioned and/or located inside the center support assembly 1410 and may travel or run up an interior of the center support assembly or tubular assembly 1410 to an associated one or more hinging assemblies and/or covers (e.g., hinging assemblies and/or covers 121 or 122). In some embodiments, the one or more steel cables 1415 1416 1417 and 1418 may be coupled, attached or connected to a linear actuator to move the one or more steel cables 1415 1416 1417 1418 in an up or down fashion which in turn may rotate the one or more hinging assemblies and/or covers 1420 1421 1422 and 1423 to open or closed positions (or positions in between). In some embodiments, the rotation of the one or more hinging assemblies and/or covers 1420 1421 1422 and 1423 may cause the arm support assemblies 1431 1432 1433 1434 1435 1436 1437 and 1438 and thus the connected arms to move to an expanded or open position (or if the linear actuator moves down, the coupled arm support assemblies and arms would move to a retracted or closed position). FIG. 14B illustrates how cables 1415 1416 1417 and 1418 are positioned inside the center support assembly. In FIG. 14B, part of the center support assembly 1410 (e.g., a middle or bottom section) is removed in order to illustrate a location of the cables 1415 1416 1417 and 1418 with respect to the center support assembly 1410.

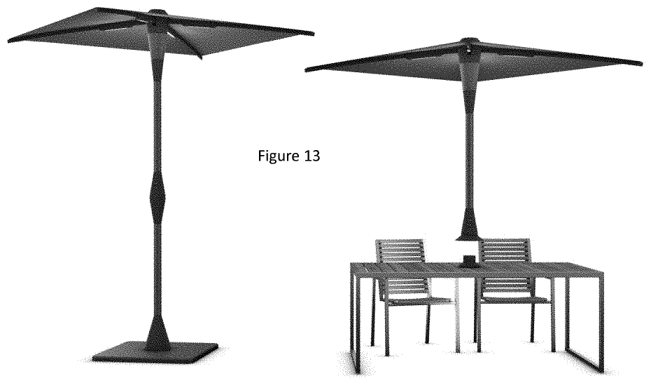

FIG. 15A illustrates a hinging assembly and cover according to some embodiments. FIG. 15B illustrates a cable being inserted into a hinging assembly or plating assembly according to some embodiments. In embodiments, each hinging assembly and cover (e.g., hinging assembly 1420) may comprise or include two covers 1510 and 1515, which may be hinging assembly covers. In some embodiments, cover 1510 may illustrate an exterior side of the cover assembly whereas cover 1515 may illustrate an interior side of the cover assembly. In some embodiments, the covers 1510 and 1515 may have respective openings 1571 and 1573 in a center (which may be circular) which may allow for passage of an inner hub of one of the hinging plates or spooling plates (as is described later). In some embodiments, the covers 1510 and 1515 may be made utilizing additive manufacturing techniques. In some embodiments, the covers 1510 and 1515 may be comprised of a plastic material and/or a composite material.

In some embodiments, each hinging assembly and cover (e.g., hinging assembly 1420) may includes round hinging plates (or spooling plates) 1520 and 1525. In some embodiments, the hinging plates or spooling plates 1520 and 1525 may be connected or coupled to each other. In some embodiments, a plurality of fasteners 1570 may connect or attach the spooling plates 1520 and 1525 to each other (which may be represented by the circles in FIG. 15). In some embodiments, an exterior side 1525 of the hinging plate may comprise an outer plate 1581 (which may be a circular plate). In some embodiments, the fasteners 1570 may be located on the outer plate 1581. In some embodiments, an exterior side 1525 of the hinging plate or spooling plate may further comprise an inner hub 1580, which may be raised with respect to the outer plate 1581. In some embodiments, the inner hub 1580 has a higher height or width than the outer plate 1581. In some embodiments, the inner hub may comprise opening or threaded openings 1572, which may receive fasteners or connectors for the arm support assemblies. In some embodiments, an interior side 1520 of a hinging plate or spooling plate may include a cable insertion channel 1521 into which an end of a cable may be positioned or placed. In some embodiments, the cable insertion channel 1521 may keep the cable within the hinging plates or spooling plates 1520 1525 so the cable does not move. In some embodiments, a cable insertion channel 1521 may include an end piece channel 1522 to provide additional security and keep the cable from moving. In some embodiments, the cable insertion channel 1521 may wrap an interior circumference of the interior side of the hinging plates or spooling plates 1520 1525. In some embodiments, the cable may be placed into the cable insertion channel 1521 and then hinging plate 1525 may be placed on top and connected to an interior hinging plate 1520. In some embodiments, the completed hinging plate or spooling plate (e.g., 1520 and 1525) may then be inserted into an interior side 1515 of the cover and then the exterior side 1510 of the cover may be attached or connected to the interior side 1515 of the cover. In some embodiments, the hinging plates or spooling plates 1520 and 1525 may be made or manufactured utilizing additive manufacturing techniques. In some embodiments, the hinging plates or spooling plates 1520 and 1525 may be made of plastic, composite and/or a lightweight metal. Thus, in some embodiments, a hinging assembly and/or cover may be constructed or assembled, by placing a flexible part 1531 of a steel cable 1529 into a cable insertion channel 1521 of the interior side 1520 of a hinging plate or spooling plate. In some embodiments, an exterior side 1525 of a hinging plate or spooling plate may be placed onto the interior side 1520 of the hinging plate or spooling plate and then fasteners 1570 may be utilized to connect or attach the interior side 1520 to the exterior side 1525. After this is assembled, inner hubs or plates 1580 may be present on the hinging plate or spooling plate. The hinging plate or spooling plate may be placed into an interior side 1515 of the cover where one or the inner hubs or plates 1580 may pass through the opening 1573 of the interior side 1515 and the opening 1571 of the exterior side of the cover assembly 1510. In some embodiments, the exterior side 1510 of the cover may then be placed over the interior side 1515 and the assembled hinging assembly or plates. In some embodiments, the cable 1529 (e.g., the solid part 1531 of the cable 1529) may exit from a bottom section of the hinging assembly and/or cover (e.g., 1420, 1421, 1422, 1423). In some embodiments, an rectangular piece 1530 of a cable 1529 may be placed into a similar shaped recess in the interior side 1520 of the hinging assembly or plate assembly.

In some embodiments, the one or more wires or cables 1529 may have an end piece 1530, a flexible part 1531 and/or a solid part 1532. In some embodiments, the one or more wires 1529 may be made of steel and/or a lightweight metal. In some embodiments, the end piece 1530 of the wires or cables 1529 may be inserted or positioned into the end piece channel 1522. In some embodiments, the flexible part 1531 of the one or more wires or cables 1529 may wrap around and be positioned or inserted into the cable insertion channel 1521. In some embodiments, the solid part 1532 of the wires or cables 1529 may exit from a bottom side of the hinging assemblies and/or cover. In some embodiments, the movement of the one or more steel cables 1415 1416 1417 1418 may causes the associated one or more hinging assemblies or covers to rotate in a clockwise or counterclockwise manner. The use of the steel cables allows heavier arms to be utilized due to the strength of the steel cable. FIG. 15B illustrates a cable 1529 that has been inserted into the interior side 1520 of the hinging plate or spooling plate and also placed into the interior side 1515 of the cover. In other words, in some embodiments, the one or more steel cables 1529 may be enclosed and/or attached between two hinging plates or spooling plates 1520 and 1525 and then place the two hinging plates or spooling plates 1520 and 1512 (and cables 1529) between two covers 1510 and 1515.

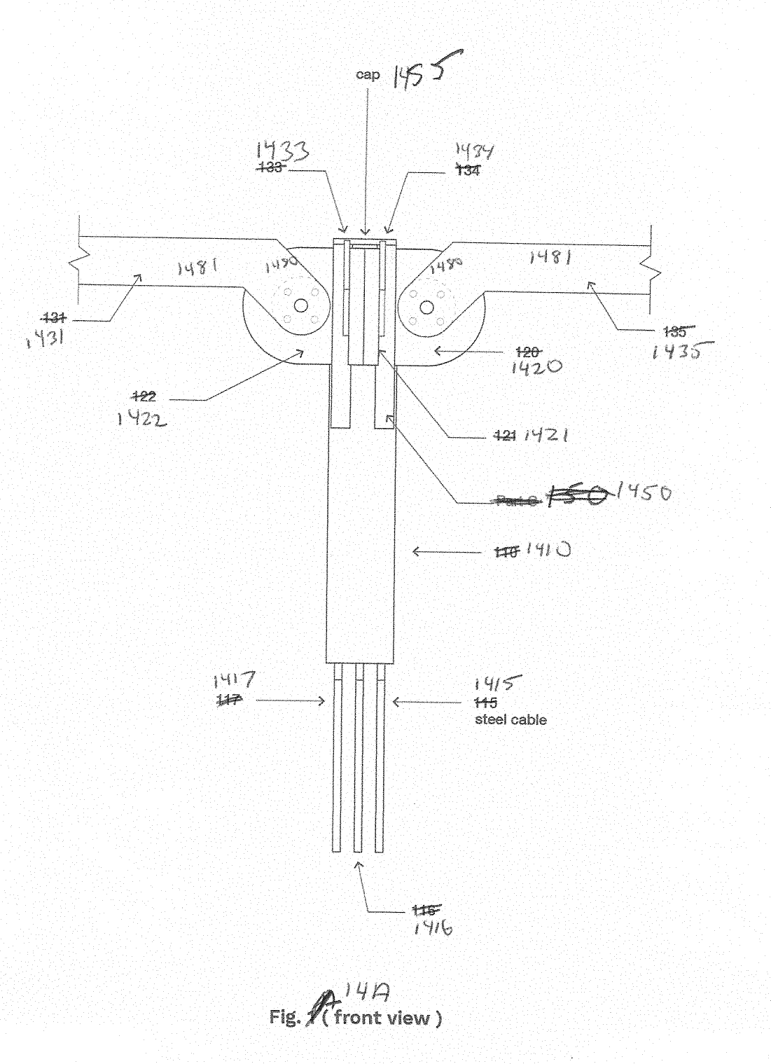

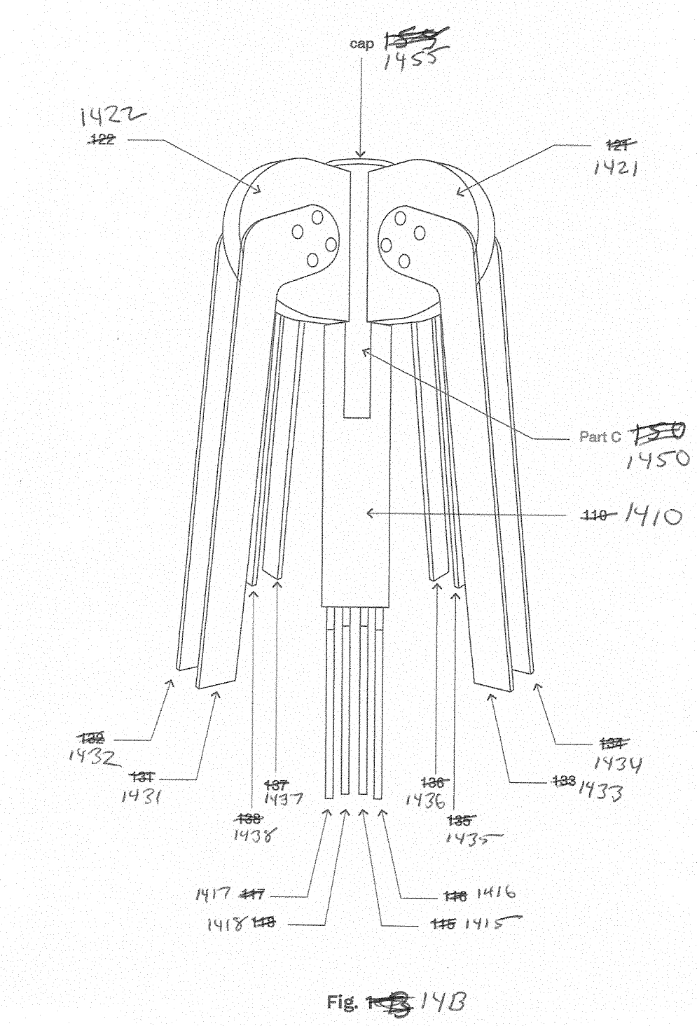

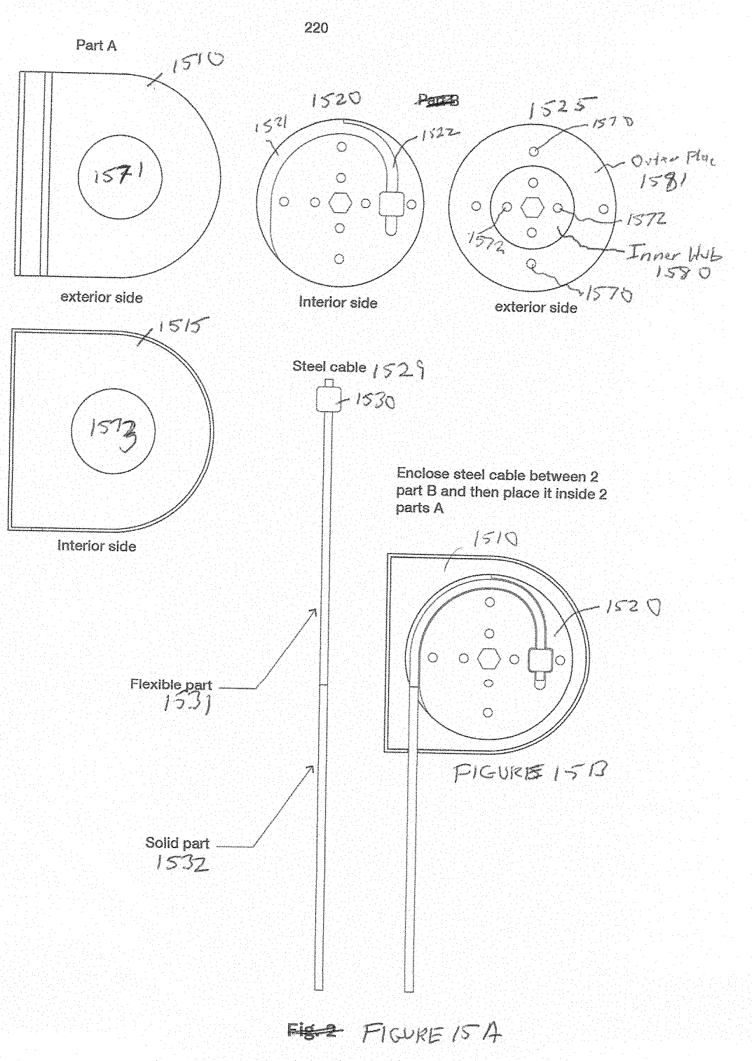

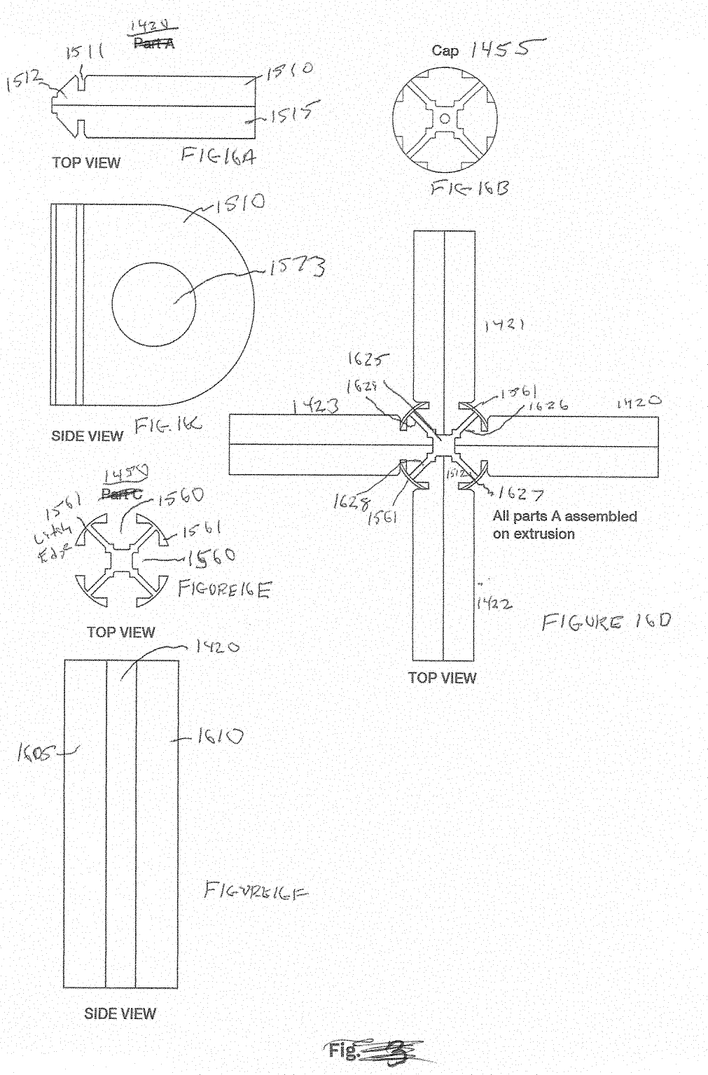

FIG. 16A illustrates a top view of a hinging assembly and/or cover assembly according to some embodiments. FIG. 16B illustrates a top view of a cap for an arm support connector tube or shaft according to some embodiments. FIG. 16C illustrates a side view of an assembled hinging assembly and/or cover assembly according to embodiments. FIG. 16D illustrates connection of one or more hinging assemblies and/or covers to the arm support connector tube or shaft according to some embodiments. FIG. 16E illustrates a top view of an arm support connector tube or shaft according to some embodiments. FIG. 16F illustrates a side view of an assembled hinging assembly and cover being attached to two arm support assemblies according to some embodiments. With respect to FIG. 16A, a hinging assembly and/or cover assembly may comprise an interior side 1510 and 1515. In some embodiments, at one end (the end closes to the center support assembly of the umbrella), the hinging assembly or cover assembly may comprise one or more channels or openings 1511 and an insertion piece 1512. In FIG. 16A, there are two channels or openings. With respect to FIG. 16B, this drawing illustrates the pieces of the arm support connector tube or shaft that are covered by the cap 1455. FIG. 16C illustrates an assembled hinging assembly and/or cover assembly 1420 according to some embodiments. In FIG. 16D, the arm support connector tube 1450 may comprise one or more insertion openings or channels 1560 (there are four insertion opening or channels in FIG. 16D) and one or more latches or edges 1561. In some embodiments, the removable or detachable hinging assembly or cover assembly 1420 may be inserted into an opening 1560 of the arm support connector tube or shaft 1450. In some embodiments, the insertion piece 1512 of the hinging assembly and/or cover assembly 1420 may be inserted into the opening of the arm support connector tube or shaft 1450. In other words, the insertion piece 1512 may mate with the opening 1560 because they are the same shape. In some embodiments, the latches or edges 1561 may mate or attach to the openings 1511 in the hinging assembly and/or cover assembly 1420 to keep the hinging assembly and/or cover assembly 1420 in the arm support connector tube or shaft 1450. In some embodiments, the latches or edges 1561 may be one piece or may be two pieces. In some embodiments, the latches or edges 1561 (if one piece) may have one side to prevent one hinging assembly and/or cover assembly from moving and may have another side to keep a second hinging assembly and/or cover assembly 1420 from moving. In some embodiments, the opening or channel 1511 and the insertion piece 1512 in the hinging assembly and cover 1420 may run a length of the height of the hinging assembly and/or cover assembly 1420. In some embodiments, an insertion opening 1560 and the latches or edges 1561 may run a length of the height of the arm support connector tube or shaft 1450. FIG. 16D illustrates when four hinging assemblies and/or cover assemblies 1420 1421 1422 1423 may be inserted into four openings 1560 of the arm support connector tube or shaft 1450 and are kept in place by the latches or edges 1561 of the arm support connector tube or shaft 1450. In some embodiments, the arm support connector tube may include a central post 1625 and four spokes 1626 1627 1628 and 1629 connected to the central post, wherein the four spokes to create four openings.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor. The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including,” “incorporating,” “includes,” “incorporates,” and “having” (and their derivatives), as used in the specification and claims, are interchangeable with and shall have the same meaning as the word “comprising.”

The processor, controller, microprocessor, or controller, as disclosed herein can be configured with instructions to perform any one or more steps of any method as disclosed herein.

As used herein, the term “or” is used inclusively to refer items in the alternative and in combination. As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

The above disclosure is sufficient to enable one of ordinary skill in the art to practice the invention and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. An arm expansion assembly, comprising:
a cable;
a hinging assembly and cover; the cable entering a bottom portion of the hinging assembly and cover and enclosed by the hinging assembly and cover; and
a first arm support assembly and a second arm support assembly, the first arm support assembly connected to a first side of the hinging assembly and cover and the second arm support assembly connected to the second side of the hinging assembly and cover.

2. The arm expansion assembly of claim 1, wherein the cable has a flexible part and a solid part, the flexible part enclosed by the hinging assembly and cover.

3. The arm expansion assembly of claim 1, the hinging assembly and cover, the cover assembly to comprise an interior side cover and an exterior side cover, and the hinging assembly to comprise an interior side hinging assembly and an exterior side hinging assembly, wherein the interior side hinging assembly is coupled to the exterior side hinging assembly with the cable disposed in between the interior side hinging assembly and exterior side hinging assembly.

4. The arm expansion assembly of claim 3, wherein the interior side hinging assembly comprise a cable insertion channel, the cable insertion channel to receive the cable and hold the cable in place when the interior side hinging assembly is connected to the exterior side hinging assembly.

5. The arm expansion assembly of claim 4, wherein a flexible part of the cable is inserted in the cable insertion channel.

6. The arm expansion assembly of claim 4, wherein the hinging assembly is positioned inside the interior side of the cover assembly and the exterior side of the cover assembly to be connected to the interior side of the cover assembly to complete the hinging assembly and cover.

7. The arm expansion assembly of claim 4, wherein four fasteners are utilized to connect the interior side of the hinging assembly to the exterior side of the hinging assembly.

8. The arm expansion assembly of claim 3, the hinging assembly comprising an outer plate, a first inner hub assembly and a second inner hub assembly, the first inner hub assembly connected to one side of the outer plate, the second inner hub assembly connected to an opposite side of the outer plate.

9. The arm expansion assembly of claim 8, therein the outer plate, the first inner hub assembly and the second inner hub assembly are circular in shape.

10. The arm expansion assembly of claim 9, the first inner hub assembly and the second inner hub assembly including two or more threaded holes, the two or more threaded holes to receive fasteners to connect the two or more arm support assemblies to the first inner hub assembly and the second inner hub assembly.

11. The arm expansion assembly of claim 10, the interior side of the cover assembly comprising a first circular opening, wherein the first hub assembly is positioned within the first circular opening and the exterior side of the cover assembly comprising a second circular opening, wherein the second hub assembly is positioned within the second circular opening.

12. An umbrella, comprising:
a center support assembly;
an arm support connector tube;
two or more arms; and
two or more arm support assemblies, the two or more arms connected to an associated two or more arm support assemblies, the two or more arm support assemblies each comprising:
a cable;
a hinging assembly and cover; the cable entering a bottom portion of the hinging assembly and cover and enclosed by the hinging assembly and cover; and
a first arm support assembly and a second arm support assembly, the first arm support assembly connected to a first side of the hinging assembly and cover and the second arm support assembly connected to the second side of the hinging assembly and cover,.

13. The umbrella of claim 12, further comprising
one or more shading fabric sections connected to the two or more arms.

14. The umbrella of claim 12, wherein the arm support connector tube is connected to a top section of the center support assembly.

15. The umbrella of claim 14, wherein the arm support connector tube to comprise a central post and four spokes connected to the central post, wherein the four spokes to create four openings.

16. The umbrella of claim 15, wherein one side or end of the hinging assembly and cover is inserted into one of the openings of the four openings of the arm support connector tube.

17. The umbrella of claim 16, the arm support connector tube to further comprise four tabs or edges, a first tab or edge to hold the hinging assembly and cover within the arm support connector tube.

18. The umbrella of claim 14, further comprising a cap, the cap covering a top portion of the arm support connector tube to prevent moisture from entering the arm support connector tube.

19. The umbrella of claim 16, the hinging assembly and cover to further comprise an opening or channel, the opening or channel to engage with the first tab or edge to hold the hinging assembly and cover within the arm support connector tube.
